(19) United States
(12) Patent Application Publication
(10) Pub. No.: US 2007/0103606 A1
(43) Pub. Date: May 10, 2007

(54) PROJECTOR

(75) Inventors: Toshiaki HASHIZUME, Suwa-shi, Nagano-ken (JP); Hiroaki YANAI, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/614,148

(22) Filed: Dec. 21, 2006

Related U.S. Application Data
(62) Division of application No. 11/427,568, filed on Jun. 29, 2006.

(30) Foreign Application Priority Data
Feb. 24, 2006 (JP) 2006-047872
Jun. 22, 2006 (JP) 2006-172245
Jun. 22, 2006 (JP) 2006-172246
Feb. 24, 2006 (JP) 2006-047873
Apr. 26, 2006 (JP) 2006-121650
Apr. 26, 2006 (JP) 2006-121652
Jul. 1, 2005 (JP) 2005-193440
Feb. 24, 2006 (JP) 2006-047871
Apr. 26, 2006 (JP) 2006-121651
Jun. 22, 2006 (JP) 2006-172244

(51) Int. Cl. G02F 1/1335

(52) U.S. Cl. 349/5

(57) ABSTRACT

A projector includes an illuminating device that emits an illuminating light beam; a liquid crystal device that modulates the illuminating light beam from the illuminating device in accordance with image information; a projection optical system that projects light modulated by the liquid crystal device; a polarizing plate arranged on at least one of a light incident side and a light emitting side of the liquid crystal device, and made of a polarizing layer; a liquid crystal device side light-transmissive member adhered to a surface of the liquid crystal device side in the polarizing layer of the polarizing plate; and an opposite side light-transmissive member adhered to a surface on the side opposed to the surface of the liquid crystal device side in the polarizing layer of the polarizing plate; wherein the liquid crystal device side light-transmissive member and the opposite side light-transmissive member are made of an inorganic material.

### BACKGROUND

1. Technical Field

The present invention relates to a projector.

2. Related Art

In the projector having a liquid crystal device as an electro-optic modulator, a polarizing plate (hereinafter called an incident side polarizing plate in a certain case) as a polarizer is arranged on a light incident side of the liquid crystal device. A polarizing plate (hereinafter called an emitting side polarizing plate in a certain case) as an analyzer is arranged on a light emitting side of the liquid crystal device. In this emitting side polarizing plate, light passing through no emitting side polarizing plate is internally absorbed. Therefore, a large quantity of heat is generated and a rise in temperature of the emitting side polarizing plate is caused. Therefore, the emitting side polarizing plate is deteriorated and polarizing characteristics of the emitting side polarizing plate are reduced, and the contrast of a projecting image is reduced and contrast irregularities, color irregularities, etc. are generated. Accordingly, a problem exists in that quality of the projecting image is reduced.

Therefore, a projector having a structure for sticking a transparent substrate of a thermal conductive property to a cross dichroic prism and further sticking the emitting side polarizing plate to this transparent substrate of the thermal conductive property is disclosed as a projector for solving such a problem (e.g., see JP-A-2002-90873 and JP-A-2000-352615). In accordance with this projector, heat generated in the emitting side polarizing plate is radiated to the cross dichroic prism having large heat capacity through the transparent substrate of the thermal conductive property. Therefore, the rise in temperature of the emitting side polarizing plate can be restrained. Therefore, it is possible to restrain that the emitting side polarizing plate is deteriorated and the polarizing characteristics of the emitting side polarizing plate are reduced. As its result, it is possible to restrain that the contrast of the projecting image is reduced and the contrast irregularities, the color irregularities, etc. are generated so that the quality of the projecting image is reduced.

However, in a recent projector, high brightness formation of the projector is further advanced, and a large quantity of heat is generated in the emitting side polarizing plate in comparison with the related art, and the rise in temperature of the emitting side polarizing plate is easily caused in comparison with the related art. Therefore, the rise in temperature of the emitting side polarizing plate easily causes the problem that the emitting side polarizing plate is deteriorated and the polarizing characteristics of the emitting side polarizing plate are reduced, and the contrast of the projecting image is reduced and the contrast irregularities, the color irregularities, etc. are generated so that the quality of the projecting image is reduced.

Such a problem is not a problem caused in only the emitting side polarizing plate as an analyzer, but is similarly caused in the case of the incident side polarizing plate as a polarizer. Namely, this problem is similarly caused in all the polarizing plates.

### SUMMARY

An advantage of some aspects of the invention can be to provide a projector for restraining that the quality of the projecting image is reduced by the rise in temperature of the polarizing plate in comparison with the related art.

An exemplary projector according to an aspect of the invention can comprise: an illuminating device that emits an illuminating light beam; a liquid crystal device that modulates the illuminating light beam from the illuminating device in accordance with image information; a projection optical system that projects light modulated by the liquid crystal device; a polarizing plate arranged on at least one of a light incident side and a light emitting side of the liquid crystal device, and constructed by a polarizing layer; a liquid crystal device side light-transmissive member adhered to a surface of the liquid crystal device side in the polarizing layer of the polarizing plate; and an opposite side light-transmissive member adhered to a surface on the side opposed to the surface of the liquid crystal device, side in the polarizing layer of the polarizing plate; the liquid crystal device side light-transmissive member and the opposite side light-transmissive member are made of an inorganic material.

Therefore, in accordance with the projector of the aspect of the invention, there is no generation of disturbance of molecular orientation in the support layer since the polarizing plate has no support layer. Namely, since there is no birefringence due to thermal distortion in the support layer between the polarizing layer and the liquid crystal device, there is no case in which polarizing characteristics as the polarizing plate are greatly reduced and quality of a projecting image is greatly reduced by a rise in temperature of the polarizing plate.

Further, in the exemplary projector according to an aspect of the invention, the liquid crystal device side light-transmissive member is adhered to the surface of the liquid crystal device side in the polarizing layer, and the opposite side light-transmissive member is adhered to a surface of the side opposed to the surface of the liquid crystal device side in the polarizing layer. Therefore, heat generated in the polarizing layer can be efficiently transmitted to the liquid crystal device side light-transmissive member and the opposite side light-transmissive member without interposing the support layer. Therefore, the rise in temperature of the polarizing layer can be restrained.

Further, in the exemplary projector according to an aspect of the invention, a predetermined mechanical strength can be obtained since the polarizing plate constructed by the polarizing layer is nipped from both sides by the liquid crystal device side light-transmissive member and the opposite side light-transmissive member.

Since the support layer used in the polarizing plate is normally an organic member, its coefficient of thermal conductivity is low and temperature is easily raised. Further, the support layer made of the organic member is deteriorated and is disturbed in molecular orientation under a condition of high temperature and high humidity. Accordingly, the polarizing plate having the support layer made of the organic member is greatly reduced in polarizing characteristics by heat and greatly reduces quality of the projecting image.

However, in the exemplary projector according to an aspect of the invention, such a disadvantage is not caused since the polarizing plate has no support layer. Namely, the reduction in quality of the projecting image can be restrained.

In the projector of the aspect of the invention, the liquid crystal device side light-transmissive member, the polarizing layer and the opposite side light-transmissive member are respectively preferably stuck by a pressure sensitive adhesive or an adhesive.

Generation of surface reflection at interfaces between the respective members is restrained and light transmittance can be raised by setting such a construction. As its result, brightness of the projecting image can be improved.

Further, even when linear expansion coefficients of the liquid crystal device side light-transmissive member, the polarizing layer and the opposite side light-transmissive member are different from each other, no separation on sticking faces between the respective members is easily caused, and a reduction in long period reliability can be restrained.

In the exemplary projector according to an aspect of the invention, the liquid crystal device side light-transmissive member and the opposite side light-transmissive member can be are a light-transmissive substrate made of sapphire or crystal.

Since the light-transmissive substrate made of these materials is very excellent in thermal conductive property, heat generated in the polarizing layer can be efficiently radiated to the system exterior, and the rise in temperature of the polarizing layer can be effectively restrained.

In the exemplary projector according to an aspect of the invention, the light-transmissive substrate made of sapphire or crystal can be arranged with respect to the polarizing layer such that an optic axis of the light-transmissive substrate made of sapphire or crystal is approximately parallel to or approximately perpendicular to a polarizing axis of the polarizing layer.

When the light-transmissive substrate made of sapphire or crystal is used as the liquid crystal device side light-transmissive member and the opposite side light-transmissive member, no polarizing state of light passing through the light-transmissive substrate made of sapphire or crystal is also changed by setting the above construction.

Further, thermal deformation of the polarizing layer can be restrained by conforming an axial direction large in thermal expansion in the light-transmissive substrate made of sapphire or crystal, and a stretched direction of the polarizing layer.

In this specification, “the polarizing axis of the polarizing layer” means the polarizing axis of light passing the polarizing layer.

Further, in the exemplary projector according to an aspect of the invention, an amount of deviation from the optic axis of the liquid crystal device side light-transmissive member to the axis that may be in parallel with or perpendicular to the polarizing axis of the polarizing layer may be smaller than an amount of deviation from the optic axis of the opposite side light-transmissive member to the axis that is in parallel with or perpendicular to the polarizing axis of the polarizing layer.

The above structure can constrain the chance of a polarizing state of light, even if the light-transmissive substrates as the light-transmissive members are made of sapphire or quartz. Such light emits from the polarizing layer and enters into the liquid crystal device, if the polarizing layer is located at the light incident side. Otherwise, the light bundle is incident into the polarizing layer and detected, if the polarizing layer is located at the light emitting side.

In the exemplary projector according to an aspect of the invention, the liquid crystal device side light-transmissive member and the opposite side light-transmissive member can be a light-transmissive substrate made of quartz glass, hard glass, crystallized glass or a sintered body of cubic crystal.

Since the light-transmissive substrate made of these materials is small in birefringence, a reduction in quality of a light beam passing the light-transmissive substrate can be restrained, and a reduction in quality of the light beam incident to the polarizing plate or the light beam emitted from the polarizing plate can be restrained. Further, since the light-transmissive substrate made of these materials is small in thermal expansion coefficient, deformation of the polarizing plate itself can be restrained by adhering the polarizing plate having a property large in extension and deformation due to heat to the light-transmissive substrate made of such a material small in thermal expansion coefficient.

In the exemplary projector according to an aspect of the invention, one light-transmissive member of the liquid crystal device side light-transmissive member and the opposite side light-transmissive member can be a light-transmissive substrate made of quartz glass, hard glass, crystallized glass or a sintered body of cubic crystal, and the other light-transmissive member is a light-transmissive substrate made of sapphire or crystal.

When the temperature of a vicinity of the polarizing layer is higher than a predetermined temperature, the liquid crystal device side light-transmissive member is preferably the light-transmissive substrate made of sapphire or crystal from the viewpoint of reducing thermal load of the polarizing layer, The opposite side light-transmissive member is preferably the light-transmissive substrate made of quartz glass, hard glass, crystallized glass or the sintered body of the cubic crystal from the viewpoint of restraining the change of a polarizing state of the light beam incident to the polarizing layer or the light beam emitted from the polarizing layer.

When the temperature of the vicinity of the polarizing layer is lower than the predetermined temperature, the liquid crystal device side light-transmissive member is preferably the light-transmissive substrate made of quartz glass, hard glass, crystallized glass or the sintered body of the cubic crystal from the viewpoint of restraining the change of the polarizing state of the light beam incident to the polarizing layer or the light beam emitted from the polarizing layer. The opposite side light-transmissive member is preferably the light-transmissive substrate made of sapphire or crystal from the viewpoint of reducing thermal load of the polarizing layer.

As the liquid crystal device side light-transmissive member and the opposite side light-transmissive member, it is also possible to preferably use a light-transmissive substrate constructed by white plate glass, a light-transmissive substrate constructed by Pyrex®, a light-transmissive substrate constructed by YAG polycrystal, a light-transmissive substrate constructed by oxynitriding aluminum, etc. in addition to the above materials,

In the exemplary projector according to an aspect of the invention, a light-transmissive member arranged on the light incident side among the liquid crystal device side light-transmissive member and the opposite side light-transmissive member can be a polarization separating optical element having a function for transmitting linearly polarized light having an axis in a predetermined direction among incident light, and reflecting the other light.

In accordance with such a construction, linearly polarized light having an axis in a predetermined direction among light incident to the light-transmissive member is transmitted through the polarization separating optical element, and is incident to the polarizing layer. On the other hand, the other light, i.e., light (a polarizing component not transmitted through the polarizing layer) to be inhibited in advancement to the polarizing layer is reflected on the polarization separating optical element, and is escaped to the system exterior. Therefore, light of the polarizing component not transmitted through the polarizing layer is almost removed by the polarization separating optical element as a former stage. Therefore, heat generation itself in the polarizing layer is effectively restrained, and the rise in temperature of the polarizing layer can be further effectively restrained.

In the projector of the aspect of the invention, as the polarization separating optical element, it is possible to preferably use a polarization separating optical element constructed by a dielectric multilayer film, a polarization separating optical element of a wire grid type formed by arraying many fine metallic thin wires, a polarization separating optical element using an XY type polarizing film having polarizing characteristics of an XY type by laminating plural films having a biaxial direction property, etc.

In the exemplary projector according to an aspect of the invention, the projector can further comprise a condenser lens arranged on the light incident side of the liquid crystal device, and the opposite side light-transmissive member adhered to the surface of the polarizing layer arranged on the light incident side of the liquid crystal device is adhered to a light emitting face of the condenser lens.

In accordance with such a construction, heat generated in the polarizing layer (light incident side polarizing plate) arranged on the light incident side of the liquid crystal device can be transmitted to the condenser lens through the opposite side light-transmissive member. Therefore, the rise in temperature of the polarizing layer can be further restrained.

Further, since the opposite side light-transmissive member is adhered to the condenser lens comparatively large in heat capacity, the rise in temperature of the opposite side light-transmissive member and the incident side polarizing plate is restrained and heat radiating performance of the projector can be raised.

In the exemplary projector according to an aspect of the invention, the projector can further comprise: a color separating light guide optical system that separates the illuminating light beam from the illuminating device into plural color lights, and guides the color lights to an illuminated area; plural liquid crystal devices that modulates each of the plural color lights separated by the color separating light guide optical system in accordance with the image information as the liquid crystal device; and a cross dichroic prism having plural light incident end faces to which the respective color lights modulated by the plural liquid crystal devices are incident, and also having a light emitting end face that emits synthesized color light, and the polarizing plate adhered to the liquid crystal device side light-transmissive member and the opposite side light-transmissive member is arranged on the light emitting side of at least one liquid crystal device among the plural liquid crystal devices, and the opposite side light-transmissive member is adhered to the light incident end face of the cross dichroic prism.

In accordance with such a construction, heat generated in the polarizing layer in the polarizing plate (emitting side polarizing plate) arranged on the light emitting side of at least one liquid crystal device among the plural liquid crystal devices can be transmitted to the cross dichroic prism through the opposite side light-transmissive member. Therefore, the rise in temperature of the polarizing layer can be further restrained.

Further, since the opposite side light-transmissive member is adhered to the cross dichroic prism comparatively large in heat capacity, the rise in temperature of the opposite side light-transmissive member and the emitting side polarizing plate is restrained, and heat radiating performance of the projector can be raised.

In the exemplary projector according to an aspect of the invention, the projector can further comprise: a case that internally stores each optical system; and a thermal conductive member that transmits heat in at least one of a portion between the liquid crystal device side light-transmissive member and the case, and a portion between the opposite side light-transmissive member and the case.

In accordance with such a construction, heat generated in the polarizing layer is radiated to the case through the liquid crystal device side light-transmissive member, the opposite side light-transmissive member and the thermal conductive member. Therefore, heat radiating performance of the projector can be raised.

The thermal conductive member is preferably made of a metal.

In the exemplary projector according to an aspect of the invention, a cool wind flow path that cools at least one of the liquid crystal device side light-transmissive member and the opposite side light-transmissive member can be arranged.

In accordance with such a construction, at least one of the liquid crystal device side light-transmissive member and the opposite side light-transmissive member can be cooled by a cool wind from the cool wind flow path. Therefore, the rise in temperature of at least one of the liquid crystal device side light-transmissive member and the opposite side light-transmissive member is restrained, and heat generated in the polarizing layer can be efficiently removed.

### BRIEF DESCRIPTION OF THE DRAWINGS

The invention will be described with reference to the accompanying drawings, wherein like numbers reference like elements.

FIG. 1 is a view showing an optical system of a projector 1000 in accordance with exemplary embodiment 1.

FIGS. 2A and 2B are views shown to explain an optical device 510 in accordance with exemplary embodiment 1.

FIGS. 3A and 3B are views shown to explain a main portion of the optical device 510 in accordance with exemplary embodiment 1.

FIGS. 4A and 4B are views shown to explain an optical device 512 in accordance with a modified example of exemplary embodiment 1.

FIGS. 5A and 5B are views shown to explain an optical device 514 in accordance with exemplary embodiment 2.

FIG. 6 is a view in which a vicinity of a polarization separating optical element 460R is seen from a side face.

FIGS. 7A and 7B are views shown to explain a projector 1006 in accordance with exemplary embodiment 3.

FIGS. 8A and 8B are views shown to explain a projector 1008 in accordance with exemplary embodiment 4.

FIGS. 9A and 9B are views shown to explain a projector 1010 in accordance with exemplary embodiment 5.

### DESCRIPTION OF EXEMPLARY EMBODIMENTS

Optical devices and projectors of the invention will next be explained on the basis of exemplary embodiments shown in the drawings.

### Exemplary Embodiment 1

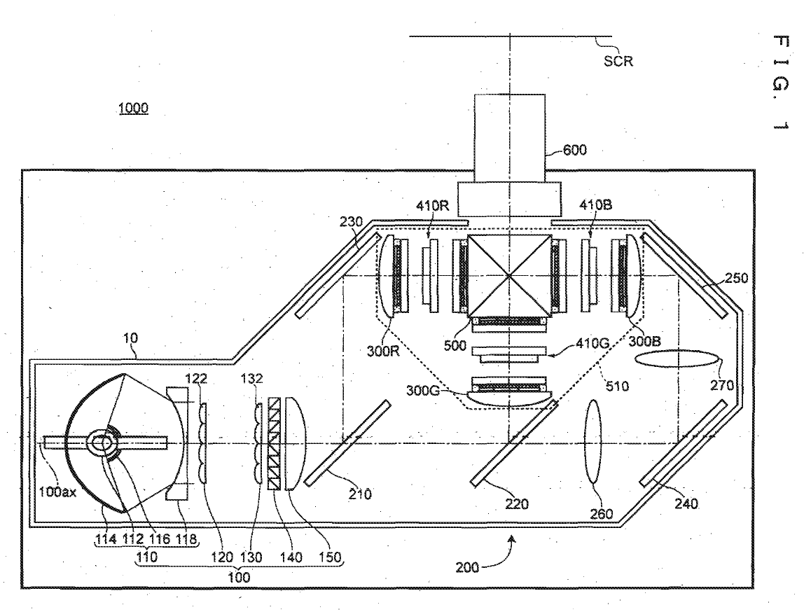

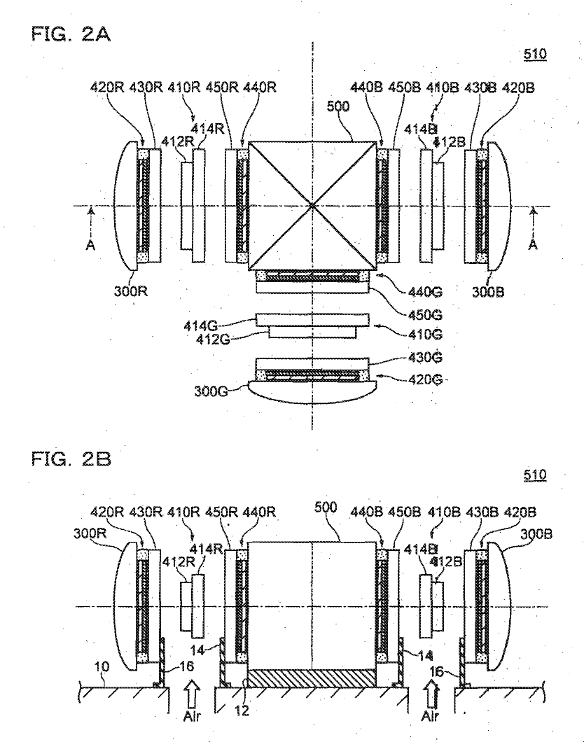

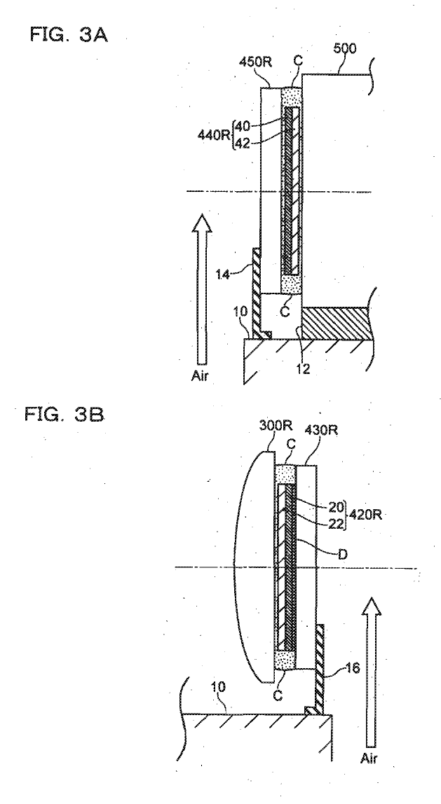

FIG. 1 is a view showing an optical system of a projector 1000 in accordance with exemplary embodiment 1. FIGS. 2A and 2B are views shown to explain an optical device 510 in accordance with exemplary embodiment 1. FIG. 2A is a view in which the optical device 510 is seen from an upper face. FIG. 2B is an A-A sectional view of FIG. 2A. FIGS. 3A and 3B are views shown to explain a main portion of the optical device 510 in accordance with exemplary embodiment 1. FIG. 3A is a view in which a vicinity of an emitting side polarizing plate 440R is seen from a side face. FIG. 3B is a view in which a vicinity of an incident side polarizing plate 420R is seen from a side face.

As shown in FIG. 1, the projector 1000 in accordance with exemplary embodiment 1 has an illuminating device 100, a color separating light guide optical system 200, the optical device 510 and a projection optical system 600. The color separating light guide optical system 200 separates an illuminating light beam from the illuminating device 100 into three color lights of red light, green light and blue light, and guides these color lights to an illuminated area. The optical device 510 has three liquid crystal devices 410R, 410G, 410B as an electro-optic modulator for modulating each of the three color lights separated by the color separating light guide optical system 200 in accordance with image information, and also has a cross dichroic prism 500 for synthesizing the color lights modulated by the three liquid crystal devices 410R, 410G, 410B. The projection optical system 600 projects the light synthesized by the cross dichroic prism 500 onto a projecting face such as a screen SCR, etc. Each of these optical systems is stored in a case 10.

The illuminating device 100 has a light source device 110 as a light source for emitting the illuminating light beam approximately parallel on the illuminated area side, and also has a first lens array 120 having plural first small lenses 122 for dividing the illuminating light beam emitted from the light source device 110 into plural partial light beams. The illuminating device 100 also has a second lens array 130 having plural second small lenses 132 corresponding to the plural first small lenses 122 of the first lens array 120, and has a polarization converting element 140 for conforming the illuminating light beam not conformed in a polarizing direction and emitted from the light source device 110 to linearly polarized light of about one kind. The illuminating device 100 further has a superposing lens 150 for superposing each partial light beam emitted from the polarization converting element 140 in the illuminated area.

The light source device 110 has an elliptical face reflector 114 as a reflector, and also has a light emitting tube 112 having a light emitting center near a first focal point of the elliptical face reflector 114. The light source device 110 also has an auxiliary mirror 116 having a reflecting face opposed to a reflecting concave face of the elliptical face reflector 114, and also has a concave lens 118 for converting convergent light reflected on the elliptical face reflector 114 into approximately parallel light. The light source device 110 emits a light beam with an illuminating optical axis 100ax as a central axis.

The light emitting tube 112 has a tube bulb portion, and a pair of seal portions extending on both sides of the tube bulb portion.

The elliptical face reflector 114 has a neck shape portion of a sleeve shape inserted and fixedly attached to one seal portion of the light emitting tube 112, and also has a reflecting concave face for reflecting light radiated from the light emitting tube 112 toward a second focal point position.

The auxiliary mirror 116 is arranged so as to be opposed to the elliptical face reflector 114 through the tube bulb portion of the light emitting tube 112, and returns light not directed to the elliptical face reflector 114 among the light radiated from the light emitting tube 112 to the light emitting tube 112, and makes this returned light incident to the elliptical face reflector 114.

The concave lens 118 is arranged on the illuminated area side of the elliptical face reflector 114. The concave lens 118 is constructed so as to set light from the elliptical face reflector 114 to be approximately parallel.

The first lens array 120 has a function as a light beam dividing optical element for dividing light from the concave lens 118 into plural partial light beams. The first lens array 120 has a construction having the plural first small lenses 122 arrayed in a matrix shape within a plane perpendicular to the illuminating optical axis 100ax. An outer shape of the first small lens 122 is a similar shape with respect to the outer shape of an image forming area of the liquid crystal devices 410R, 410G, 410B although an explanation using illustration is omitted.

The second lens array 130 is an optical element for converging the plural partial light beams divided by the first lens array 120. Similar to the first lens array 120, the second lens array 130 has a construction having the plural second small lenses 132 arrayed in a matrix shape within a plane perpendicular to the illuminating optical axis 100ax.

The polarization converting element 140 emits each partial light beam divided by the first lens array 120 as linearly polarized light of about one kind conformed in a polarizing direction.

The polarization converting element 140 has a polarization separating layer for transmitting one linearly polarized light component among polarizing components included in the illuminating light beam from the light source device 110, and reflecting the other linearly polarized light component in a direction perpendicular to the illuminating optical axis 100ax. The polarization converting element 140 also has a reflecting layer for reflecting the other linearly polarized light component reflected on the polarization separating layer in a direction parallel to the illuminating optical axis 100ax. The polarization converting element 140 further has a phase difference plate for converting the other linearly polarized light component reflected on the reflecting layer into one linearly polarized light component.

The superposing lens 150 is an optical element for converging the plural partial light beams transmitted via the first lens array 120, the second lens array 130 and the polarization converting element 140, and superposing the plural partial light beams near the image forming area in the liquid crystal devices 410R, 410G, 410B. The superposing lens 150 shown in FIG. 1 is constructed by one lens, but may be also constructed by a composite lens formed by combining plural lenses.

The color separating light guide optical system 200 has dichroic mirrors 210, 220, reflecting mirrors 230, 240, 250, an incident side lens 260 and a relay lens 270. The color separating light guide optical system 200 has a function for separating the illuminating light beam emitted from the illuminating device 100 into the three color lights of red light, green light and blue light, and guiding the respective color lights to the liquid crystal devices 410R, 410G, 410B as an illuminating object.

The dichroic mirrors 210, 220 are optical elements each forming a wavelength selecting film for reflecting the light beam of a predetermined wavelength area onto a substrate, and transmitting the light beams of other wavelength areas. The dichroic mirror 210 arranged at the former stage of an optical path is a mirror for reflecting a red light component, and transmitting the other color light components. The dichroic mirror 220 arranged at the latter stage of the optical path is a mirror for transmitting a blue light component and reflecting a green light component.

The red light component reflected on the dichroic mirror 210 is bent by the reflecting mirror 230, and is incident to the liquid crystal device 410R for red light through a condenser lens 300R. On the other hand, the green light component among the green light component and the blue light component transmitted through the dichroic mirror 210 is reflected on the dichroic mirror 220 and is incident to the liquid crystal device 410G for green light through a condenser lens 300G Further, the blue light component transmitted through the dichroic mirror 220 is converged and bent by the incident side lens 260, the relay lens 270 and the reflecting mirrors 240, 250, and is incident to the liquid crystal device 410B for blue light through a condenser lens 300B. The incident side lens 260, the relay lens 270 and the reflecting mirrors 240, 250 have a function for guiding the blue light component transmitted through the dichroic mirror 220 until the liquid crystal device 410B for blue light.

Such incident side lens 260, relay lens 270 and reflecting mirrors 240, 250 are arranged in the optical path of the blue light to prevent a reduction of utilization efficiency of light due to dispersion of light, etc. since the length of the optical path of the blue light is longer than the lengths of the optical paths of the other color lights. In the projector 1000 in accordance with exemplary embodiment 1, such a construction is set since the length of the optical path of the blue light is long. However, a construction for lengthening the length of the optical path of the red light and using the incident side lens 260, the relay lens 270 and the reflecting mirrors 240, 250 in the optical path of the red light is also considered.

The optical device 510 has the three liquid crystal devices 410R, 410G, 410B for modulating the respective three color lights separated by the color separating light guide optical system 200 in accordance with image information. The optical device 510 also has the cross dichroic prism 500 for synthesizing the respective color lights modulated by the three liquid crystal devices 410R, 410G, 410B. The optical device 510 also has the three condenser lenses 300R, 300G, 300B arranged on the respective light incident sides of the three liquid crystal devices 410R, 410G, 410B. The optical device 510 also has three incident side polarizing plates 420R, 420G, 420B arranged on the respective light incident sides of the three liquid crystal devices 410R, 410G, 410B. The optical device 510 also has three second light-transmissive members 430R, 430G, 430B adhered to faces of the light transmitting sides of the three incident side polarizing plates 420R, 420G, 420B. The optical device 510 also has three emitting side polarizing plates 440R, 440G, 440B arranged on the respective light transmitting sides of the three liquid crystal devices 410R, 410G, 410B. The optical device 510 further has three first light-transmissive members 450R, 450G, 450B respectively adhered to faces of the light incident sides in the three emitting side polarizing plates 440R, 440G, 440B.

The condenser lens 300R is arranged to convert each partial light beam emitted from the second lens array 130 into light approximately parallel with respect to a principal ray of each partial light beam. The condenser lens 300R is held by an unillustrated holding member of a thermal conductive property, and is arranged in the case 10 through this holding member of the thermal conductive property. The other condenser lenses 300G, 300B are also constructed similarly to the condenser lens 300R.

The liquid crystal devices 410R, 410G, 410B modulate the illuminating light beam in accordance with image information, and become an illuminating object of the illuminating device 100.

In each of the liquid crystal devices 410R, 410G, 410B, a liquid crystal as an electro-optic substance is enclosed in a pair of transparent glass substrates. For example, a polysilicon TFT is set to a switching element, and a polarizing direction of linearly polarized light of one kind emitted from the incident side polarizing plates 420R, 420G, 420B is modulated in accordance with a given image signal. The liquid crystal devices 410R, 410G, 410B are held in a liquid crystal device holding frame constructed by e.g., a die-cast frame manufactured by aluminum although this construction is omitted in illustration of the drawings.

As shown in FIGS. 2A and 28, the incident side polarizing plates 420R, 420G, 420B are arranged between the condenser lenses 300R, 300G, 300B and the liquid crystal devices 410R, 410G, 410B, and have a function for transmitting only the linearly polarized light having an axis in a predetermined direction among lights emitted from the condenser lenses 300R, 300G, 300B, and absorbing the other lights.

As shown in FIG. 3B, the incident side polarizing plate 420R has a polarizing layer 20 and a support layer 22 for supporting the polarizing layer 20. The incident side polarizing plate 420R is adhered to a light emitting face of the condenser lens 300R through an adhesive layer C such that the support layer 22 is located on the side (condenser lens 300R side) opposed to the liquid crystal device 410R in the polarizing layer 20. As the polarizing layer 20, for example, it is possible to preferably use a polarizing layer formed such that polyvinyl alcohol (PVA) is dyed by iodine or a dichromatic dye and is uniaxially stretched and molecules of this dye are arrayed in one direction. The polarizing layer 20 formed in this way absorbs the polarized light of a direction parallel to the above uniaxially stretched direction, and transmits the polarized light of a direction perpendicular to the above uniaxially stretched direction. In the polarizing layer 20, force intended to be returned from a stretched state to an original state is large. Accordingly, a support layer for supporting the polarizing layer 20 is arranged to regulate this force. As the support layer 22, it is possible to preferably use a support layer constructed by triacetyl cellulose (TAC). The other incident side polarizing plates 420G, 420B are also constructed similarly to the incident side polarizing plate 420R.

The second light-transmissive members 430R, 430G, 430B are respectively arranged on the liquid crystal device sides (the light emitting sides) of the incident side polarizing plates 420R, 420G, 420B. For example, the second light-transmissive members 430R, 430G, 430B are a light-transmissive substrate made of sapphire. The light-transmissive substrate made of sapphire has a high thermal conductivity coefficient of about 40 W/(m·K) and is very high in hardness and has a small coefficient of thermal expansion and is not easily damaged and has a high transparent degree. When a cheap property is seriously considered as brightness of a middle degree, a light-transmissive substrate made of crystal having a thermal conductivity coefficient of about 10 W/(m·K) may be also used. The thicknesses of the second light-transmissive members 430R, 430G, 430B are preferably set to 0.2 mm or more from the viewpoint of the thermal conductive property, and are preferably set to 2.0 mm or less from the viewpoint of compactness of the device.

As shown in FIG. 3B, a face of the light incident side in the incident side polarizing plate 420R and a face of the light emitting side in the condenser lens 300R are adhered through an adhesive layer C. Further, a face of the light emitting side in the incident side polarizing plate 420R and a face of the light incident side in the second light-transmissive member 430R are stuck through a sticking layer D. Thus, generation of surface reflection at the interface between the respective members is restrained, and light transmittance can be raised. As its result, brightness of a projecting image can be improved. Further, even when the linear expansion coefficients of the second light-transmissive member 430R, the incident side polarizing plate 420R and the condenser lens 300R are different from each other, no separation on sticking faces between the respective members is easily caused, and a reduction of long period reliability can be restrained. A face of the light incident side in the incident side polarizing plate 420R and a face of the light emitting side in the condenser lens 300R may be also stuck by a pressure sensitive adhesive. A face of the light emitting side in the incident side polarizing plate 420R and a face of the light incident side in the second light-transmissive member 430R may be also adhered by an adhesive. Peripheral portions of the other incident side polarizing plates 420G, 420B are also constructed similarly to the peripheral portion of the incident side polarizing plate 420R.

The adhesive layer C is formed around the incident side polarizing plates 420R, 420G; 420B. For example, an adhesive of an UV hardening property, an adhesive of a visible light short wavelength hardening property, etc. can be suitably used as the adhesive used in the adhesive layer C.

As shown in FIGS. 2A and 2B, the emitting side polarizing plates 440R, 440G, 440B are arranged between the liquid crystal devices 410R, 410G, 410B and the cross dichroic prism 500, and have a function for transmitting only linearly polarized light having an axis in a predetermined direction among lights emitted from the liquid crystal devices 410R, 410G, 410B, and absorbing the other lights.

As shown in FIG. 3A, the emitting side polarizing plate 440R has a polarizing layer 40 and a support layer 42 for supporting the polarizing layer 40. The emitting side polarizing plate 440R is adhered to a light incident end face of the cross dichroic prism 500 through the adhesive layer C such that the support layer 42 is located on the side (cross dichroic prism 500 side) opposed to the liquid crystal device 410R in the polarizing layer 40. A material similar to that of the incident side polarizing plate 420R can be used as the polarizing layer 40 and the support layer 42. The other emitting side polarizing plates 440G, 440B are also constructed similarly to the emitting side polarizing plate 440R.

First light-transmissive members 450R, 450G, 450B are respectively arranged on the liquid crystal device sides (light incident sides) of the emitting side polarizing plates 440R, 440G, 440B. Unillustrated reflection preventing layers are formed on faces of the liquid crystal device sides of the first light-transmissive members 450R, 450G, 450B. Similar to the second light-transmissive members 430R, 430G, 430B, the first light-transmissive members 450R, 450G 450B are formed by a light-transmissive substrate made of e.g., sapphire.

As shown in FIG. 3A, a face of the light incident side in the emitting side polarizing plate 440R and a face of the light emitting side in the first light-transmissive member 450R, and a face of the light emitting side in the emitting side polarizing plate 440R and a light incident end face in the cross dichroic prism 500 are respectively adhered through the adhesive layer C. Thus, generation of surface reflection at interfaces between the respective members is restrained, and light transmittance can be raised. As its result, brightness of a projecting image can be improved. Further, even when linear expansion coefficients of the first light-transmissive member 450R, the emitting side polarizing plate 440R and the cross dichroic prism 500 are different from each other, no separation on sticking faces between the respective members is easily caused, and a reduction of long period reliability can be restrained. A pressure sensitive adhesive may be also used instead of the adhesive. Peripheral portions of the other emitting side polarizing plates 440G, 440B are constructed similarly to the peripheral portion of the emitting side polarizing plate 440R.

The adhesive layer C is formed around the emitting side polarizing plates 440R, 440G, 440B.

These incident side polarizing plates 420R, 420G, 420B and emitting side polarizing plates 440R, 440G, 440B are set and arranged such that the directions of mutual polarizing axes are perpendicular.

The cross dichroic prism 500 is an optical element for synthesizing an optical image modulated every each color light emitted from each of the emitting side polarizing plates 440R, 440G, 440B, and forming a color image. As shown in FIG. 2A, the cross dichroic prism 500 has three light incident end faces to which color lights modulated by the liquid crystal devices 410R, 410G, 410B are respectively incident, and also has a light emitting end face for emitting the synthesized color light. This cross dichroic prism 500 approximately has a square shape seen from a plane and formed by sticking four rectangular prisms. A dielectric multi-layer film is formed at an interface of an approximately X-shape at which the rectangular prisms are stuck to each other. The dielectric multi-layer film formed at one interface of the approximately X-shape reflects red light, and the dielectric multi-layer film formed at the other interface reflects blue light. The red light and the blue light are bent by these dielectric multi-layer films, and their advancing directions are conformed to the advancing direction of green light so that the three color lights are synthesized.

The cross dichroic prism 500 is arranged in the case 10 through a spacer 12 of a thermal conductive property (see FIG. 2B).

A color image emitted from the cross dichroic prism 500 is enlarged and projected by the projection optical system 600, and a large screen image is formed on the screen SCR.

At least one fan and plural cool wind flow paths for cooling each optical system, etc. are arranged within the projector 1000 although their illustration is omitted. The air taken-in from the exterior of the projector 1000 is circulated within the projector 1000 by these fan and plural cool wind flow paths, and is discharged to the exterior. As shown in FIGS. 2A and 2B, the air flowed-in from a ventilating hole (cool wind flow path) arranged in the case 10 promotes heat radiation from the optical device 510.

Thus, heat of each optical system (each member of the optical device 510) of the projector 1000 can be efficiently removed.

The projector 1000 in accordance with exemplary embodiment 1 constructed in this way will be further explained in detail on the basis of the construction of a member arranged in the optical path of red light among the optical paths of the respective three color lights to simplify the following explanation.

In the projector 1000 in accordance with exemplary embodiment 1, as shown in FIGS. 2A and 2B, the first light-transmissive member 450R and the emitting side polarizing plate 440R are arranged between the liquid crystal device 410R and the cross dichroic prism 500. The first light-transmissive member 450R is adhered to a face of the light incident side in the emitting side polarizing plate 440R. A face of the light emitting side in the emitting side polarizing plate 440R is adhered to a light incident end face in the cross dichroic prism 500.

Therefore, heat generated in the emitting side polarizing plate 440R can be transmitted from both sides of the emitting side polarizing plate 440R to the first light-transmissive member 450R and the cross dichroic prism 500. Therefore, a rise in temperature of the emitting side polarizing plate 440R can be restrained. Further, since no emitting side polarizing plate 440R comes in contact with the outside air, the invasion of moisture from the outside air can be restrained. Therefore, it is possible to restrain that the support layer of the emitting side polarizing plate 440R is expanded and deformed by the rise in temperature of the emitting side polarizing plate 440R and the invasion of moisture from the outside air. Thus, generation of disturbance of molecular orientation in the support layer can be restrained. As its result, it is possible to restrain that polarization characteristics as the emitting side polarizing plate are reduced and quality of the light beam passing the emitting side polarizing plate 440R is reduced.

Accordingly, the projector 1000 in accordance with exemplary embodiment 1 becomes a projector for restraining that the quality of a projecting image is reduced by the rise in temperature of the emitting side polarizing plate in comparison with the related art.

Further, in the projector 1000 in accordance with exemplary embodiment 1, the emitting side polarizing plate 440R is adhered to the cross dichroic prism 500 comparatively large in heat capacity. Therefore, the rise in temperature of the emitting side polarizing plate 440R is restrained, and heat radiating performance of the projector can be raised. Further, since the cross dichroic prism 500 is connected to the case 10 through the spacer 12 of the thermal conductive property, heat capacity can be further increased and the heat radiating performance of the projector can be further raised.

In the projector 1000 in accordance with exemplary embodiment 1, as shown in FIG. 3A, the emitting side polarizing plate 440R has the support layer 42 for supporting the polarizing layer 40 on only the light emitting side of the polarizing layer 40.

Thus, there is no generation of disturbance of the molecular orientation in the support layer of the light incident side. Namely, since no birefringence due to thermal distortion in the support layer exists between the polarizing layer 40 and the liquid crystal device 410R, light modulated by the liquid crystal device 410R reaches the polarizing layer 40 in a state as it is. Therefore, there is no case in which polarizing characteristics as the emitting side polarizing plate are greatly reduced and the quality of the projecting image is greatly reduced by the rise in temperature of the emitting side polarizing plate 440R. In this case, even if the polarizing characteristics in the support layer 42 of the light emitting side are slightly reduced by the rise in temperature, its reduction of the polarizing characteristics is not detected as light in the polarizing layer 40. Therefore, no quality of the projecting image is greatly reduced.

In the projector 1000 in accordance with exemplary embodiment 1, as mentioned above, the first light-transmissive member 450R is adhered to the face of the light incident side in the emitting side polarizing plate 440R, and the face of the light emitting side in the emitting side polarizing plate 440R is adhered to the light incident end face in the cross dichroic prism 500. Therefore, even when the emitting side polarizing plate 440R has a structure having the support layer 42 on only the light emitting side of the polarizing layer 40, the projector 1000 can obtain a predetermined mechanical strength.

In the projector 1000 in accordance with exemplary embodiment 1, as shown in FIGS. 2A and 2B, the incident side polarizing plate 420R and the second light-transmissive member 430R are arranged between the condenser lens 300R and the liquid crystal device 410R. The second light-transmissive member 430R is adhered to the face of the light emitting side in the incident side polarizing plate 420R. The face of the light incident side in the incident side polarizing plate 420R is adhered to the face of the light emitting side in the condenser lens 300R.

Thus, heat generated in the incident side polarizing plate 420R can reach the second light-transmissive member 430R and the condenser lens 300R from both sides of the incident side polarizing plate 420R. Therefore, the rise in temperature of the incident side polarizing plate 420R can be restrained. Further, since no incident side polarizing plate 420R comes in contact with the outside air, the invasion of moisture from the outside air can be restrained. Therefore, it is possible to restrain that the support layer of the incident side polarizing plate 420R is expanded and deformed by the rise in temperature of the incident side polarizing plate 420R and the invasion of moisture from the outside air. Thus, the generation of disturbance of molecular orientation in the support layer can be restrained. As its result, it is possible to restrain that polarizing characteristics as the incident side polarizing plate are reduced and quality of a light beam passing the incident side polarizing plate 420R is reduced.

Therefore, the projector 1000 in accordance with exemplary embodiment 1 becomes a projector for further restraining that the quality of the projecting image is reduced by the rise in temperature of the incident side polarizing plate and the emitting side polarizing plate in comparison with the related art.

Further, in the projector 1000 in accordance with exemplary embodiment 1, the incident side polarizing plate 420R is adhered to the condenser lens 300R comparatively large in heat capacity. Therefore, the rise in temperature of the incident side polarizing plate 420R is restrained and heat radiating performance of the projector can be raised. Further, since the condenser lens 300R is connected to the case 10 through a holding member of a thermal conductive property, heat capacity can be further increased and the heat radiating performance of the projector can be further raised.

In the projector 1000 in accordance with exemplary embodiment 1, as shown in FIG. 3B, the incident side polarizing plate 420R has the support layer 22 for supporting the polarizing layer 20 on only the light incident side of the polarizing layer 20.

Thus, there is no generation of disturbance of molecular orientation in the support layer of the light emitting side. Namely, since there is no birefringence due to thermal distortion in the support layer between the polarizing layer 20 and the liquid crystal device 410R, light properly conformed to linearly polarized light having an axis in a predetermined direction in the polarizing layer 20 reaches the liquid crystal device 410R in a state as it is. Therefore, there is no case in which polarizing characteristics as the incident side polarizing plate are greatly reduced and quality of the projecting image is greatly reduced by the rise in temperature of the incident side polarizing plate. In this case, even if the polarizing characteristics in the support layer 22 of the light incident side are slightly reduced by the rise in temperature, this reduction of the polarizing characteristics is compensated by the polarizing layer 20 of the incident side polarizing plate 420R, and is not detected as light in error by the polarizing layer 40 of the emitting side polarizing plate 440R. Therefore, no quality of the projecting image is greatly reduced.

In the projector 1000 in accordance with exemplary embodiment 1, as mentioned above, the second light-transmissive member 430R is adhered to the face of the light emitting side in the incident side polarizing plate 420R. Further, the face of the light incident side in the incident side polarizing plate 420R is adhered to the face of the light emitting side in the condenser lens 300R. Therefore, even when the incident side polarizing plate 420R has a structure having the support layer 22 on only the light incident side of the polarizing layer 20, the projector 1000 has a predetermined mechanical strength.

In the projector 1000 in accordance with exemplary embodiment 1, the first light-transmissive member 450R is a light-transmissive substrate made of sapphire.

Since the light-transmissive substrate made of sapphire is very excellent in thermal conductive property, heat generated in the emitting side polarizing plate 440R can be efficiently radiated to the system exterior, and deterioration of the polarizing characteristics caused by the rise in temperature of the emitting side polarizing plate 440R can be further restrained.

In the projector 1000 in accordance with exemplary embodiment 1, the first light-transmissive member 450R is arranged with respect to the emitting side polarizing plate 440R such that an optic axis of the first light-transmissive member 450R is approximately parallel to or approximately perpendicular to a polarizing axis of the polarizing layer 40.

Even when the light-transmissive substrate made of sapphire is used as the first light-transmissive member 450R, no polarizing state of light passing through the first light-transmissive member 450R is changed by the above construction. Further, thermal deformation of the emitting side polarizing plate 440R can be restrained by conforming an axial direction large in thermal expansion in the first light-transmissive member 450R and a stretched direction of the emitting side polarizing plate 440R.

In the projector 1000 in accordance with exemplary embodiment 1, the second light-transmissive member 430R is a light-transmissive substrate made of sapphire.

Since the light-transmissive substrate made of sapphire is very excellent in thermal conductive property, heat generated in the incident side polarizing plate 420R can be efficiently radiated to the system exterior, and deterioration of the polarizing characteristics caused by the rise in temperature of the incident side polarizing plate 420R can be further restrained.

In the projector 1000 in accordance with exemplary embodiment 1, the second light-transmissive member 430R is arranged with respect to the incident side polarizing plate 420R such that an optic axis of the second light-transmissive member 430R is approximately parallel to or approximately perpendicular to a polarizing axis of the polarizing layer 20.

when the light-transmissive substrate made of sapphire is used as the second light-transmissive member 430R, no polarizing state of light passing through the second light-transmissive member 430R is also changed by the above construction. Further, thermal deformation of the incident side polarizing plate 420R can be restrained by conforming an axial direction large in thermal expansion in the second light-transmissive member 430R and a stretched direction of the incident side polarizing plate 420R.

In the projector 1000 in accordance with exemplary embodiment 1, a thermal conductive member 14 for transmitting heat between the first light-transmissive member 450R and the case 10 is further arranged (see FIG. 3A).

Thus, heat generated in the emitting side polarizing plate 440R is radiated to the case 10 through the first light-transmissive member 450R and the thermal conductive member 14 so that heat radiating performance of the projector can be raised.

In the projector 1000 in accordance with exemplary embodiment 1, a thermal conductive member 16 for transmitting heat between the second light-transmissive member 430R and the case 10 is further arranged (see FIG. 3B).

Thus, heat generated in the incident side polarizing plate 420R is also radiated to the case 10 through the second light-transmissive member 430R and the thermal conductive member 16 so that the heat radiating performance of the projector can be further raised.

For example, a metal such as aluminum, an aluminum alloy, etc. can be preferably used as materials of the thermal conductive members 14, 16.

In the projector 1000 in accordance with exemplary embodiment 1, a cool wind flow path for cooling the first light-transmissive member 450R and the second light-transmissive member 430R is arranged.

Thus, the first light-transmissive member 450R and the second light-transmissive member 430R can be cooled by a cool wind from the cool wind flow path. Therefore, a rise in temperature of the first light-transmissive member 450R and the second light-transmissive member 430R is restrained, and heat generated in the emitting side polarizing plate 440R and the incident side polarizing plate 420R can be efficiently removed.

The projector 1000 in accordance with exemplary embodiment 1 becomes a projector of long life since deterioration of the incident side polarizing plate 420R (420G, 420B) and the emitting side polarizing plate 440R (440G, 440B) can be restrained.

The optical device 510 in accordance with exemplary embodiment 1 is one portion of the construction of the projector 1000 in accordance with exemplary embodiment 1. Effects provided by the optical device 510 in accordance with exemplary embodiment 1 are overlapped with effects provided by the projector 1000 in accordance with exemplary embodiment 1. Therefore, an explanation relating to the effects of the optical device 510 in accordance with exemplary embodiment 1 is omitted.

Here, in the optical device 510 in accordance with exemplary embodiment 1, the emitting side polarizing plate 440R is a polarizing plate having the support layer 42 on only the light incident side of the polarizing layer 40. The incident side polarizing plate 420R is a polarizing plate having the support layer 22 on only the light incident side of the polarizing layer 20. However, the invention is not limited to this case, but, for example, the following modifications can be performed.

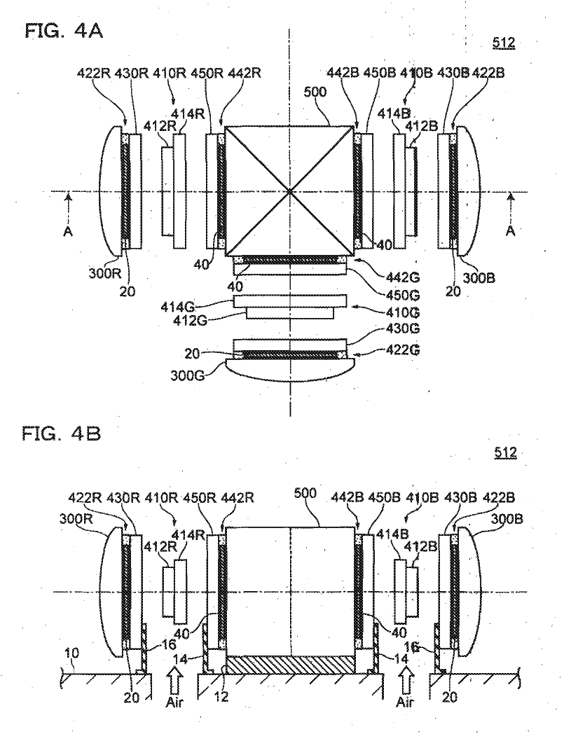

FIGS. 4A and 4B are views shown to explain an optical device 512 in accordance with a modified example of exemplary embodiment 1. FIG. 4A is a view in which the optical device 512 is seen from an upper face. FIG. 4B is a B-B sectional view of FIG. 4A. In FIGS. 4A and 4B, the same members as FIGS. 2A and 2B are designated by the same reference numerals and their detailed explanations are omitted.

In the optical device 512 in accordance with the modified example, as shown in FIGS. 4A and 4B, an emitting side polarizing plate 442R is a polarizing plate having a structure in which the support layer of the light emitting side is also omitted as well as the support layer of the light incident side. An incident side polarizing plate 422R is a polarizing plate having a structure in which the support layer of the light incident side is also omitted as well as the support layer of the light emitting side.

An incident side polarizing plate 422G and an emitting side polarizing plate 442G arranged in an optical path of green light and an incident side polarizing plate 422B and an emitting side polarizing plate 442B arranged in an optical path of blue light are similarly polarizing plates having the above structure as well as the incident side polarizing plate 422R and the emitting side polarizing plate 442R arranged in the optical path of red light.

Thus, the optical device 512 in accordance with the modified example differs from the case of the optical device 510 in accordance with exemplary embodiment 1 in the structure of the polarizing plate used as each incident side polarizing plate and each emitting side polarizing plate. However, similar to the case of the optical device 510 in accordance with exemplary embodiment 1, the first light-transmissive member 450R is adhered to a surface of the light incident side in the polarizing layer 40 of the emitting side polarizing plate 442R. A surface of the light emitting side in the polarizing layer 40 of the emitting side polarizing plate 442R is adhered to a light incident end face in the cross dichroic prism 500. The second light-transmissive member 430R is adhered to a surface of the light emitting side in the polarizing layer 20 of the incident side polarizing plate 422R. A surface of the light incident side in the polarizing layer 20 of the incident side polarizing plate 422R is adhered to a face of the light emitting side in the condenser lens 300R. Therefore, the projector becomes a projector for further restraining that quality of a projecting image is reduced by the rise in temperature of the incident side polarizing plate and the emitting side polarizing plate in comparison with the related art.

### Exemplary Embodiment 2

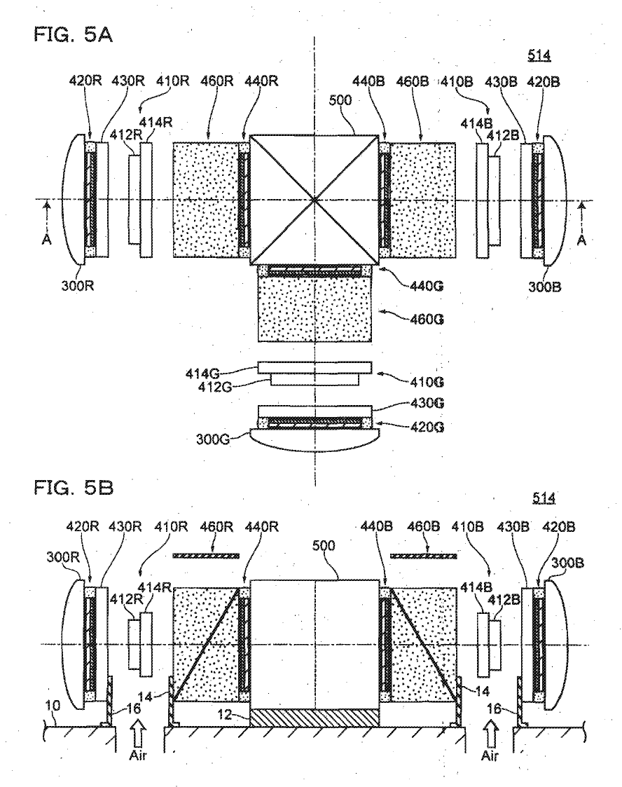

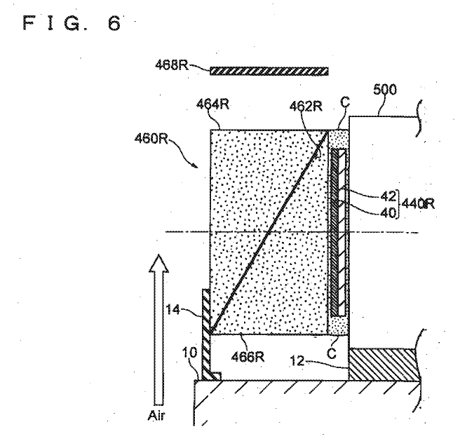

FIGS. 5A and 5B are views shown to explain an optical device 514 in accordance with exemplary embodiment 2. FIG. 5A is a view in which the optical device 514 is seen from an upper face. FIG. 5B is an A-A sectional view of FIG. 5A. FIG. 6 is a view in which a vicinity of a polarization separating optical element 460R is seen from a side face. In FIGS. 5A and 5B, the same members as FIGS. 2A and 2B are designated by the same reference numerals, and their detailed explanations are omitted.

The optical device 514 in accordance with exemplary embodiment 2 basically has a construction similar to that of the optical device 510 in accordance with exemplary embodiment 1. However, as shown in FIGS. 5A and 5B and 6, the optical device 514 differs from the optical device 510 in accordance with exemplary embodiment 1 in a member adhered to the light incident side of the emitting side polarizing plate.

Namely, in the optical device 510 in accordance with exemplary embodiment 1, the first light-transmissive members 450R, 450G, 450B are respectively adhered to the faces of the light incident sides in the emitting side polarizing plates 440R, 440G, 440B. In contrast to this, in the optical device 514 in accordance with exemplary embodiment 2, polarization separating optical elements 460R, 460G, 460B for transmitting only linearly polarized light having an axis in a predetermined direction among lights emitted from the liquid crystal devices 410R, 410G, 410B, and reflecting the other lights are adhered to faces of the light incident sides in the emitting side polarizing plates 440R, 440G, 440B.

The polarization separating optical elements 460R, 460G, 460B in the optical device 514 in accordance with exemplary embodiment 2 will be explained in detail on the basis of the construction of a member arranged in the optical path of red light among the optical paths of the respective three color lights to simplify the following explanation.

As shown in FIG. 6, the polarization separating optical element 460R has a structure in which an XY type polarizing film 462R having polarizing characteristics of an XY type by laminating plural films having a biaxial direction property is nipped by two glass prisms 464R, 466R. For example, an angle formed by a light incident face in the polarization separating optical element 460R and the XY type polarizing film 462R is set to 30 degrees. An unillustrated reflection preventing layer is formed on a face of the light incident side (liquid crystal device side) of the polarization separating optical element 460R.

In the polarization separating optical element 460R, polarized light reflected on the XY type polarizing film 462R among polarized light modulated by the liquid crystal device 410R is emitted from a side face of the polarization separating optical element 460R as it is, or is once reflected on a light incident face of the polarization separating optical element 460R and is then emitted from the side face of the polarization separating optical element 460R. In this case, since this polarized light is totally reflected on the light incident face of the polarization separating optical element 460R, a stray light level can be also reduced.

A light absorbing means 468R for absorbing the polarized light reflected on the XY type polarizing film 462R and emitted from the polarization separating optical element 460R is arranged above the polarization separating optical element 460R. Thus, since the light absorbing means 468R efficiently catches light reflected on the XY type polarizing film 462R and escaped to the system exterior, generation of the stray light in the projector can be restrained and the quality of the projecting image can be further improved. Further, since the light absorbing means 468R is arranged above the polarization separating optical element 460R, heat generated in the light absorbing means 468R is escaped above the optical system by a convection current and an influence of heat given to the optical system can be minimized.

Thus, the optical device 514 in accordance with exemplary embodiment 2 differs from the case of the optical device 510 in accordance with exemplary embodiment 1 in the member adhered to the light incident side of the emitting side polarizing plate. However, similar to the case of the optical device 510 in accordance with exemplary embodiment 1, the polarization separating optical element 460R is adhered to the face of the light incident side in the emitting side polarizing plate 440R. Further, the face of the light emitting side in the emitting side polarizing plate 440R is adhered to the light incident end face in the cross dichroic prism 500. Therefore, the projector becomes a projector for restraining that the quality of the projecting image is reduced by the rise in temperature of the emitting side polarizing plate in comparison with the related art.

In the optical device 514 in accordance with exemplary embodiment 2, the linearly polarized light having an axis in a predetermined direction among light emitted from the liquid crystal device 410R is transmitted through the polarization separating optical element 460R and is projected by the unillustrated projection optical system 600 and is projected on the unillustrated screen SCR. On the other hand, the other light, i.e., light (a polarizing component not transmitted through the polarizing layer 40 of the emitting side polarizing plate 440R) to be inhibited in advancement to the projection optical system 600 is reflected on the polarization separating optical element 460R, and is escaped to the system exterior. Therefore, the light of the polarizing component not transmitted through the polarizing layer 40 of the emitting side polarizing plate 440R among light incident to the emitting side polarizing plate 440R is almost removed by the polarization separating optical element 460R as a former stage. Therefore, heat generation itself in the emitting side polarizing plate 440R is effectively restrained, and the rise in temperature of the emitting side polarizing plate 440R can be further effectively restrained.

Further, the XY type polarizing film 462R of the polarization separating optical element 460R is a reflection type polarizing plate and is slantingly constructed with respect to the unillustrated illuminating optical axis 100ax. Accordingly, the XY type polarizing film 462R is slightly inferior in characteristics as an analyzer. However, a preferable image can be obtained since an amount unable to remove light unnecessary in the image by the polarization separating optical element 460R can be reliably interrupted by the emitting side polarizing plate 440R.

Namely, reliability of the device can be improved by partially bearing an operation as the analyzer and generation of heat by the polarization separating optical element 460R and the emitting side polarizing plate 440R.

The optical device 514 in accordance with exemplary embodiment 2 has a constriction similar to that of the optical device 510 in accordance with exemplary embodiment 1 except that the member adhered to the light incident side of the emitting side polarizing plate is different, Therefore, the optical device 514 has effects similar to those of the case of the optical device 510 in accordance with exemplary embodiment 1.

### Exemplary Embodiment 3

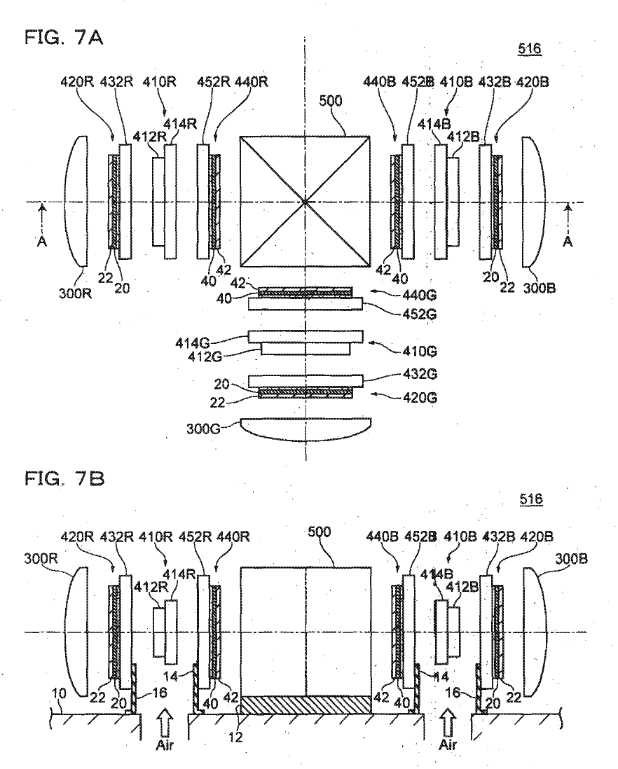

FIGS. 7A and 7B are views shown to explain a projector 1006 in accordance with exemplary embodiment 3. FIG. 7A is a view in which an optical device 516 is seen from an upper face. FIG. 7B is an A-A sectional view of FIG. 7A. In FIGS. 7A and 7B, the same members as FIGS. 2A and 2B are designated by the same reference numerals, and their detailed explanations are omitted.

Similar to the projector 1000 in accordance with exemplary embodiment 1, the projector 1006 in accordance with exemplary embodiment 3 is a projector having an illuminating device 100, a color separating light guide optical system 200, an optical device 516, and a projection optical system 600 although its illustration is omitted. The color separating light guide optical system 200 separates an illuminating light beam from the illuminating device 100 into three color lights constructed by red light, green light and blue light, and guides the three color lights to an illuminated area. The projection optical system 600 projects light synthesized by the cross dichroic prism 500 in the optical device 516 onto a projecting face of the screen SCR, etc. The illuminating device 100, the color separating light guide optical system 200 and the projection optical system 600 are the same as those explained in exemplary embodiment 1, and their detailed explanations are therefore omitted.

The optical device 516 has three liquid crystal devices 410R, 410G, 410B for modulating the respective three color lights separated by the color separating light guide optical system 200 in accordance with image information. The optical device 516 also has a cross dichroic prism 500 for synthesizing the respective color lights modulated by the three liquid crystal devices 410R, 410G, 410B. The optical device 516 also has three condenser lenses 300R, 300G, 300B arranged on respective light incident sides of the three liquid crystal devices 410R, 410G, 410B. The optical device 516 also has three incident side polarizing plates 420R, 420G, 420B arranged on the respective light incident sides of the three liquid crystal devices 410R, 410G, 410B. The optical device 516 also has three liquid crystal device side light-transmissive members 432R, 432G, 432B adhered to faces of the light emitting sides of the three incident side polarizing plates 420R, 420G, 420B. The optical device 516 also has three emitting side polarizing plates 440R, 440G, 440B arranged on the respective light emitting sides of the three liquid crystal devices 410R, 410G, 410B. The optical device 516 further has three liquid Crystal device side light-transmissive members 452R, 452G, 452B respectively adhered to faces of the light incident sides in the three emitting side polarizing plates 440R, 440G, 440B.

In the projector 1006 in accordance with exemplary embodiment 3, the support layer 22 in the incident side polarizing plate 420R is arranged on the side (light incident side) opposed to the liquid crystal device 410R in the polarizing layer 20. The support layer 42 in the emitting side polarizing plate 440R is arranged on the side (light emitting side) opposed to the liquid crystal device 410R in the polarizing layer 40.

Therefore, there is no generation of disturbance of molecular orientation in the support layer of the liquid crystal device side. Namely, there is no birefringence due to thermal distortion in the support layer between the polarizing layer 20 and the liquid crystal device 410R and between the polarizing layer 40 and the liquid crystal device 410R. Accordingly, there is no case in which polarizing characteristics as the polarizing plate are greatly reduced and quality of a projecting image is greatly reduced by a rise in temperature of the incident side polarizing plate and the emitting side polarizing plate.

In this case, even if the polarizing characteristics are slightly reduced in the support layer 42 of the emitting side polarizing plate 440R by the rise in temperature, this reduction of the polarizing characteristics is not detected as light in the polarizing layer 40 of the emitting side polarizing plate 440R. Therefore, no quality of the projecting image is greatly reduced. Further, even if the polarizing characteristics are slightly reduced in the support layer 22 of the incident side polarizing plate 420R by the rise in temperature, this reduction of the polarizing characteristics is compensated in the polarizing layer 20 of the incident side polarizing plate 420R, and is not detected as light in error in the polarizing layers 40 of the emitting side polarizing plate 440R. Therefore, no quality of the projecting image is greatly reduced.

In the projector 1006 in accordance with exemplary embodiment 3, the liquid crystal device side light-transmissive members 432R, 432G, 432B are respectively adhered to the faces of the liquid crystal device sides in the incident side polarizing plates 420R, 420G, 420B. Therefore, heat generated in the incident side polarizing plates 420R, 420G, 420B can be transmitted to the liquid crystal device side light-transmissive members 432R, 432G, 432B. Thus, the rise in temperature of the incident side polarizing plates 420R, 420G, 420B can be restrained.

In the projector 1006 in accordance with exemplary embodiment 3, the liquid crystal device side light-transmissive members 452R, 452G, 452B are respectively adhered to the faces of the liquid crystal device sides in the emitting side polarizing plates 440R, 440G, 440B. Therefore, heat generated in the emitting side polarizing plates 440R, 440G, 440B can be transmitted to the liquid crystal device side light-transmissive members 452-R, 452G, 452B. Thus, the rise in temperature of the emitting side polarizing plates 440R, 440G, 440B can be restrained.

In the projector 1006 in accordance with exemplary embodiment 3, the liquid crystal device side light-transmissive members 432R, 432G, 432B, 452R, 452G, 452B are a light-transmissive substrate made of sapphire.

Since the light-transmissive substrate made of sapphire is very excellent in thermal conductive property, heat generated in the incident side polarizing plates 420R, 420G, 420B and the emitting side polarizing plates 440R, 440G, 440B can be efficiently radiated to the system exterior Thus, the rise in temperature of the incident side polarizing plates 420R, 420G, 420B and the emitting side polarizing plates 440R, 440G, 440B can be effectively restrained.

In the projector 1006 in accordance with exemplary embodiment 3, the liquid crystal device side light-transmissive members 432R, 432G, 432B are arranged with respect to the incident side polarizing plates 420R, 420G, 420B such that optical axes of the liquid crystal device side light-transmissive members 432R, 432G, 432B are approximately parallel to or approximately perpendicular to a polarizing axis of the polarizing layer 20. Further, the liquid crystal device side light-transmissive members 452R, 452G, 452B are arranged with respect to the emitting side polarizing plates 440R, 440G, 440B such that optical axes of the liquid crystal device side light-transmissive members 452R, 452G, 452B are approximately parallel to or approximately perpendicular to a polarizing axis of the polarizing layer 40.

When the light-transmissive substrate made of sapphire is used as the liquid crystal device side light-transmissive members 432R, 432G, 432B, 452R, 452G, 452B, no polarizing state of light passing through the liquid crystal device side light-transmissive members 432R, 432G, 432B, 452R, 452G, 452B is also changed by setting the above construction.

Further, thermal deformation of the incident side polarizing plates 420R, 420G, 420B or the emitting side polarizing plates 440R, 440G, 440B can be restrained by conforming an axial direction large in thermal expansion in the liquid crystal device side light-transmissive members 432R, 432G, 432B, 452R, 452G, 452B and a stretched direction of the incident side polarizing plates 420R, 420G, 420B or the emitting side polarizing plates 440R, 440G, 440B.

The projector 1006 in accordance with exemplary embodiment 3 becomes a projector of long life since deterioration of the incident side polarizing plates 420R, 420G, 420B and the emitting side polarizing plates 440R, 440G, 440B can be restrained.

In the projector 1006 in accordance with exemplary embodiment 3, the light-transmissive substrate made of sapphire is used as the liquid crystal device side light-transmissive members 452R, 452G, 452B. However, the invention is not limited to this light-transmissive substrate, but a polarization separating optical element as explained in exemplary embodiment 2 may be also used. In this case, effects similar to those using the polarization separating optical element explained in exemplary embodiment 2 can be obtained.

### Exemplary Embodiment 4

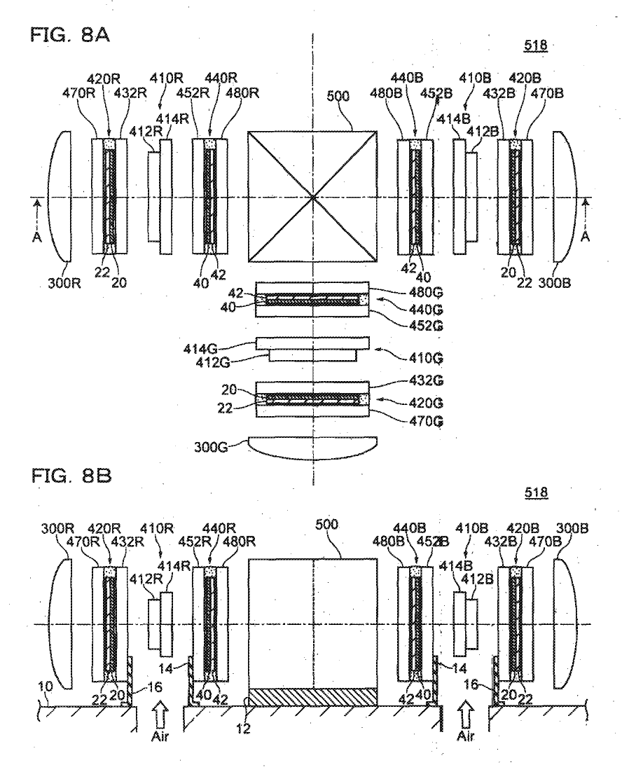

FIGS. 8A and 8B are views shown to explain a projector 1008 in accordance with exemplary embodiment 4. FIG. 8A is a view in which an optical device 518 is seen from an upper face. FIG. 8B is an A-A sectional view of FIG. 8A. In FIGS. 8A and 8B, the same members as FIGS. 7A and 7B are designated by the same reference numerals, and their detailed explanations are omitted.

The unillustrated projector 1008 in accordance with exemplary embodiment 4 basically has a construction similar to that of the projector 1006 in accordance with exemplary embodiment 3, but differs from the case of the projector 1006 in accordance with exemplary embodiment 3 in that an opposite side light-transmissive member is further arranged.

Namely, in the projector 1008 in accordance with exemplary embodiment 4, as shown in FIGS. 8A and 8B, opposite side light-transmissive members 470R, 470G, 470B are respectively adhered to the faces (light incident faces) of sides opposed to faces of the liquid crystal device sides in the incident side polarizing plates 420R, 420G, 420B. Opposite side light-transmissive members 480R, 480G, 480B are respectively adhered to the faces (light emitting faces) of sides opposed to faces of the liquid crystal device sides in the emitting side polarizing plates 440R, 440G, 440B.

Thus, the projector 1008 in accordance with exemplary embodiment 4 differs from the case of the projector 1006 in accordance with exemplary embodiment 3 in that the opposite side light-transmissive member is further arranged. However, similar to the case of the projector 1006 in accordance with exemplary embodiment 3, the support layer 22 in the incident side polarizing plate 420R is arranged on the side (light incident side) opposed to the liquid crystal device 410R in the polarizing layer 20. The support layer 42 in the emitting side polarizing plate 440R is arranged on the side (light emitting side) opposed to the liquid crystal device 410R in the polarizing layer 40. Therefore, there is no generation of disturbance of molecular orientation in the support layer of the liquid crystal device side. Namely, there is no birefringence due to thermal distortion in the support layer between the polarizing layer 20 and the liquid crystal device 410R, and between the polarizing layer 40 and the liquid crystal device 410R. Accordingly, there is no case in which polarizing characteristics as the polarizing plate are greatly reduced and quality of a projecting image is greatly reduced by the rise in temperature of the incident side polarizing plate and the emitting side polarizing plate.

In the projector 1008 in accordance with exemplary embodiment 4, the opposite side light-transmissive members 470R, 470G, 470B are respectively adhered to light incident faces in the incident side polarizing plates 420R, 420G, 420B. Therefore, heat generated in the incident side polarizing plates 420R, 420G, 420B can be transmitted to the opposite side light-transmissive members 470R, 470G, 470B. Thus, the rise in temperature of the incident side polarizing plates 420R, 420G, 420B can be restrained.

Further, since no support layers 22 in the incident side polarizing plates 420R, 420G, 420B are exposed to the exterior, it is possible to restrain that the support layer 22 is expanded and deformed by the rise in temperature of the incident side polarizing plates 420R, 420G, 420B and the invasion of moisture from the outside air. Therefore, generation of disturbance of molecules in the support layer 22 can be restrained. As a result, a reduction in quality of the projecting image can be restrained.

Furthermore, the incident side polarizing plates 420R, 420G, 420B are adhered to the opposite side light-transmissive members 470R, 470G, 470B. Therefore, a predetermined mechanical strength can be obtained even when each of the incident side polarizing plates 420R, 420G, 420B is a polarizing plate of a two-layer structure constructed by the polarizing layer 20 and one support layer 22. In this case, a structure for nipping the incident side polarizing plates 420R, 420G, 420B from both faces by the liquid crystal device side light-transmissive members 432R, 432G, 432B and the opposite side light-transmissive members 470R, 470G, 470B is set. Therefore, the mechanical strength can be further raised.

In the projector 1008 in accordance with exemplary embodiment 4, the opposite side light-transmissive members 480R, 480G, 480B are respectively adhered to the light emitting faces in the emitting side polarizing plates 440R, 440G, 440B. Therefore, heat generated in the emitting side polarizing plates 440R, 440G, 440B can be transmitted to the opposite side light-transmissive members 480R, 480G, 480B. Thus, the rise in temperature of the emitting side polarizing plates 440R, 440G, 440B can be restrained.

Further, no support layers 42 in the emitting side polarizing plates 440R, 440G, 440B are exposed to the exterior. Therefore, it is possible to restrain that the support layer 42 is expanded and deformed by the rise in temperature of the emitting side polarizing plates 440R, 440G, 440B and the invasion of moisture from the outside air. Therefore, generation of disturbance of molecules in the support layer 42 can be restrained. As a result, a reduction in quality of a projecting image can be restrained.

Furthermore, the emitting side polarizing plates 440R, 440G, 440B are adhered to the opposite side light-transmissive members 480R, 480G, 480B. Therefore, even when each of the emitting side polarizing plates 440R, 440G, 440B is a polarizing plate of a two-layer structure constructed by the polarizing layer 40 and one support layer 42, a predetermined mechanical strength can be obtained. In this case, a structure for nipping the emitting side polarizing plates 440R, 440G, 440B from both sides by the liquid crystal device side light-transmissive members 452R, 452G, 452B and the opposite side light-transmissive members 480R, 480G, 480B is set. Therefore, the mechanical strength can be further raised.

In the projector 1008 in accordance with exemplary embodiment 4, the opposite side light-transmissive members 470R, 470G, 470B, 480R, 480G, 480B are a light-transmissive substrate made of sapphire.

The light-transmissive substrate made of sapphire is very excellent in thermal conductive property. Therefore, heat generated in the incident side polarizing plates 420R, 420G, 420B and the emitting side polarizing plates 440R, 440G, 440B can be efficiently radiated to the system exterior. Thus, the rise in temperature of the incident side polarizing plates 420R, 420G, 420B and the emitting side polarizing plates 440R, 440G, 440B can be effectively restrained.

In the projector 1008 in accordance with exemplary embodiment 4, the opposite side light-transmissive members 470R, 470G, 470B are arranged with respect to the incident side polarizing plates 420R, 420G, 420B such that optical axes of the opposite side light-transmissive members 470R, 470G, 470B are approximately parallel to or approximately perpendicular to a polarizing axis of the polarizing layer 20. Further, the opposite side light-transmissive members 480R, 480G, 480B are arranged with respect to the emitting side polarizing plates 440R, 440G, 440B such that optical axes of the opposite side light-transmissive members 480R, 480G, 480B are approximately parallel to or approximately perpendicular to a polarizing axis of the polarizing layer 40.

When the light-transmissive substrate made of sapphire is used as the opposite side light-transmissive members 470R, 470G, 470B, 480R, 480G, 480B, no polarizing state of light passing through the opposite side light-transmissive members 470R, 470G, 470B, 480R, 480G, 480B is also changed by setting the above construction.

Further, thermal deformation of the incident side polarizing plates 420R, 420G, 420B or the emitting side polarizing plates 440R, 440G, 440B can be restrained by conforming an axial direction large in thermal expansion in the opposite side light-transmissive members 470R, 470G, 470B, 480R, 480G 480B, and a stretched direction of the incident side polarizing plates 420R, 420G, 420B or the emitting side polarizing plates 440R, 440G, 440B.

The projector 1008 in accordance with exemplary embodiment 4 becomes a projector of long life since deterioration of the incident side polarizing plates 420R, 420G, 420B and the emitting side polarizing plates 440R, 440G, 440B can be restrained.

The projector 1008 in accordance with exemplary embodiment 4 has a construction similar to that of the projector 1006 in accordance with exemplary embodiment 3 except that the opposite side light-transmissive member is further arranged. Therefore, the projector 1008 in accordance with exemplary embodiment 4 has effects similar to those of the case of the projector 1006 in accordance with exemplary embodiment 3.

In the projector 1008 in accordance with exemplary embodiment 4, the liquid crystal device side light-transmissive members 432R, 432G, 432B are respectively adhered to light emitting faces in the incident side polarizing plates 420R, 420G, 420B. The opposite side light-transmissive members 470R, 470G, 470B are respectively adhered to light incident faces in the incident side polarizing plates 420R, 420G, 420B. The liquid crystal device side light-transmissive members 452R, 452G, 452B are respectively adhered to light incident faces in the emitting side polarizing plates 440R, 440G, 440B. The opposite side light-transmissive members 480R, 480G, 480B are respectively adhered to light emitting faces in the emitting side polarizing plates 440R, 440G, 440B. However, the invention is not limited to this construction, but the following construction can be also adopted.

For example, in the projector 1008 in accordance with exemplary embodiment 4, the light-transmissive substrate made of sapphire is used as the liquid crystal device side light-transmissive members 452R, 452G, 452B adhered to the light incident faces of the emitting side polarizing plates 440R, 440G, 440B. However, a polarization separating optical element as explained in exemplary embodiment 2 may be also used instead of this light-transmissive substrate. In this case, linearly polarized light having an axis in a predetermined direction among light emitted from the liquid crystal devices 410R, 410G, 410B is transmitted through the polarization separating optical element and is projected by the unillustrated projection optical system 600 and is projected on the unillustrated screen SCR. On the other hand, the other light, i.e., light (a polarizing component not transmitted through the polarizing layers 40 of the emitting side polarizing plates 440R, 440G, 440B) to be inhibited in advancement to the projection optical system 600 is reflected on the polarization separating optical element and is escaped to the system exterior. Therefore, light of a polarizing component not transmitted through the polarizing layer 40 among light incident to the emitting side polarizing plates 440R, 440G, 440B is almost removed by the polarization separating optical element as a former stage. Therefore, heat generation itself in the emitting side polarizing plates 440R, 440G, 440B is effectively restrained. Thus, the rise in temperature of the emitting side polarizing plates 440R, 440G, 440B can be further effectively restrained.

Further, in the projector 1008 in accordance with exemplary embodiment 4, the light-transmissive substrate made of sapphire is used as the opposite side light-transmissive members 470R, 470G, 470B adhered to the light incident faces of the incident side polarizing plates 420R, 420G, 420B. However, a polarization separating optical element as explained in exemplary embodiment 2 may be also used instead of this light-transmissive substrate. In this case, linearly polarized light having an axis in a predetermined direction among light emitted from the condenser lenses 300R, 300G, 300B is transmitted through the polarization separating optical element, and is incident to the incident side polarizing plates 420R, 420G, 420B. On the other hand, the other light, i.e., light (a polarizing component not transmitted through the polarizing layers 20 of the incident side polarizing plates 420R, 420G, 420B) to be inhibited in advancement to the incident side polarizing plates 420R, 420G, 420B is reflected on the polarization separating optical element and is escaped to the system exterior. Therefore, light of the polarizing component not transmitted through the polarizing layers 20 of the incident side polarizing plates 420R, 420G, 420B among light emitted from the condenser lenses 300R, 300G, 300B is almost removed by the polarization separating optical element as a former stage. Therefore, heat generation itself in the incident side polarizing plates 420R, 420G, 420B is effectively restrained. Thus, the rise in temperature of the incident side polarizing plates 420R, 420G, 420B can be further effectively restrained.

As the polarization separating optical element, it is possible to preferably use a polarization separating optical element constructed by a dielectric multi-layer film, a polarization separating optical element of a wire grid type formed by arraying many fine metallic thin wires, a polarization separating optical element using an XS type polarizing film having polarizing characteristics of an XY type by laminating plural films having a biaxial direction property, etc.

Further, in the projector 1008 in accordance with exemplary embodiment 4, the opposite side light-transmissive members 480R, 480G, 480B adhered to the light emitting faces of the emitting side polarizing plates 440R, 440G, 440B, and the cross dichroic prism 500 are respectively separated and arranged. However, the opposite side light-transmissive members 480R, 480G, 480B may be also respectively adhered to plural light incident end faces of the cross dichroic prism 500. In this case, heat generated in the emitting side polarizing plates 440R, 440G, 440B can be transmitted to the cross dichroic prism 500 through the opposite side light-transmissive members 480R, 480G, 480B. Therefore, the rise in temperature of the emitting side polarizing plates 440R, 440G, 440B can be further restrained. Further, the opposite side light-transmissive members 480R, 480G, 480B are adhered to the cross dichroic prism 500 comparatively large in heat capacity. Therefore, the rise in temperature of the opposite side light-transmissive members 480R, 480G, 480B and the emitting side polarizing plates 440R, 440G, 440B is restrained, and heat radiating performance of the projector can be raised.

Further, in the projector 1008 in accordance with exemplary embodiment 4, the opposite side light-transmissive members 470R, 470G, 470B adhered to the light incident and emitting faces of the incident side polarizing plates 420R, 420G, 420B, and the condenser lenses 300R, 300G, 300B are respectively separated and arranged. However, the opposite side light-transmissive members 470R, 470G, 470B may be also respectively adhered to the light emitting faces of the condenser lenses 300R, 300G, 300B. In this case, heat generated in the incident side polarizing plates 420R, 420G, 420B can be transmitted to the condenser lenses 300R, 300G, 300B through the opposite side light-transmissive members 470R, 470G, 470B. Therefore, the rise in temperature of the incident side polarizing plates 420R, 420G, 420B can be further restrained. Further, the opposite side light-transmissive members 470R, 470G, 470B are adhered to the condenser lenses 300R, 300G, 300B comparatively large in heat capacity. Therefore, the rise in temperature of the opposite side light-transmissive members 470R, 470G, 470B and the incident side polarizing plates 420R, 420G, 420B is restrained, and heat radiating performance of the projector can be raised.

### Exemplary Embodiment 5

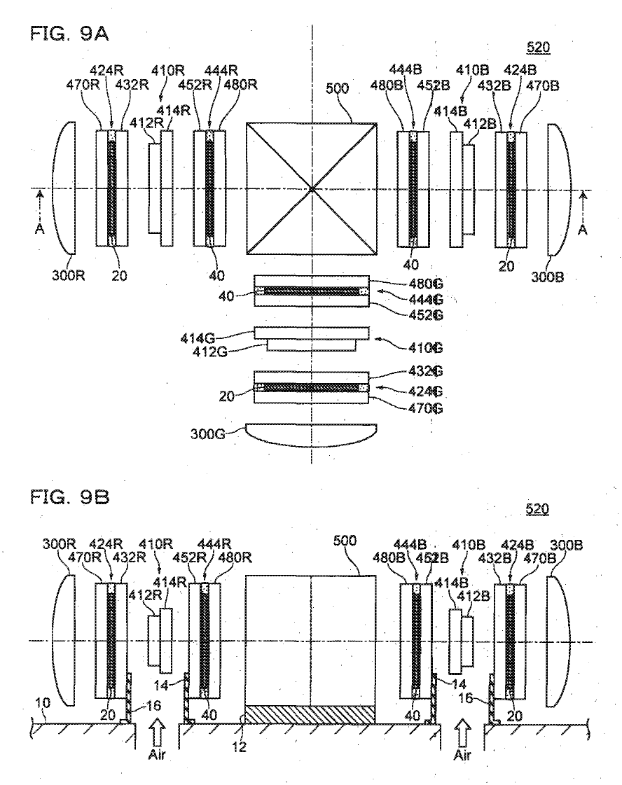

FIGS. 9A and 9B are views shown to explain a projector 1010 in accordance with exemplary embodiment 5. FIG. 9A is a view in which an optical device 520 is seen from an upper face. FIG. 9B is an A-A sectional view of FIG. 9A. In FIGS. 9A and 9B, the same members as FIGS. 2A and 2B are designated by the same reference numerals, and their detailed explanations are omitted.

The unillustrated projector 1010 in accordance with exemplary embodiment 5 basically has a construction similar to that of the projector 1008 in accordance with exemplary embodiment 4, but differs from the case of the projector 1008 in accordance with exemplary embodiment 4 in that the support layer in the polarizing plate is omitted.

Namely, in the projector 1010 in accordance with exemplary embodiment 5, as shown in FIGS. 9A and 9B, incident side polarizing plates 424R, 424G, 424B constructed by the polarizing layers 20 are used as the incident side polarizing plate, and emitting side polarizing plates 444R, 444G, 444B constructed by the polarizing layers 40 are used as the emitting side polarizing plate.

Therefore, in accordance with the projector 1010 in accordance with exemplary embodiment 5, the incident side polarizing plates 424R, 424G, 424B have no support layer. Therefore, there is no generation of disturbance of molecular orientation in the support layer. Namely, there is no birefringence due to thermal distortion in the support layer between the polarizing layers 20 and the liquid crystal devices 410R, 410G, 410B. Accordingly, there is no case in which polarizing characteristics as the incident side polarizing plate are greatly reduced and quality of a projecting image is greatly reduced by a rise in temperature of the incident side polarizing plates 424R, 424G, 424B.

In accordance with the projector 1010 in accordance with exemplary embodiment 5, no support layer is also arranged with respect to the emitting side polarizing plates 444R, 444G, 444B. Therefore, there is no generation of disturbance of molecular orientation in the support layer. Namely, there is no birefringence due to thermal distortion in the support layer between the polarizing layers 40 and the liquid crystal devices 410R, 410G, 410B. Accordingly, there is no case in which polarizing characteristics as the emitting side polarizing plate are greatly reduced and quality of a projecting image is greatly reduced by a rise in temperature of the emitting side polarizing plates 444R, 444G, 444B.

Since the support layer used in the polarizing plate is normally an organic member, its coefficient of thermal conductivity is low and temperature is easily raised. Further, the support layer made of the organic member is deteriorated and disturbed in molecular orientation in a condition of high temperature and high humidity. Accordingly, the polarizing plate having the support layer made of the organic member is greatly reduced in polarizing characteristics by heat and greatly reduces the quality of the projecting image.

However, in accordance with the projector 1010 in exemplary embodiment 5, the incident side polarizing plates 424R, 424G, 424B and the emitting side polarizing plates 444R, 444G, 444B have no support layer. Therefore, such a disadvantage is not caused. Namely, the reduction in the quality of the projecting image can be restrained.

The projector 1010 in accordance with exemplary embodiment 5 becomes a projector of long life since deterioration of the incident side polarizing plates 424R, 424G, 424B and the emitting side polarizing plates 444R, 444G, 444B can be restrained.

The projector 1010 in accordance with exemplary embodiment 5 has a construction similar to that of the projector 1008 in accordance with exemplary embodiment 4 except that the support layer in the polarizing plate is omitted. Therefore, the projector 1010 in accordance with exemplary embodiment 5 has effects similar to those of the case of the projector 1008 in accordance with exemplary embodiment 4.

In the projector 1010 in accordance with exemplary embodiment 5, the liquid crystal device side light-transmissive members 432R, 432G, 432B are respectively adhered to light emitting side surfaces in the polarizing layers 20 of the incident side polarizing plates 424R, 424G, 424B. The opposite side light-transmissive members 470R, 470G, 470B are respectively adhered to light incident side surfaces in the polarizing layers 20 of the incident side polarizing plates 424R, 424G, 424B. The liquid crystal device side light-transmissive members 452R, 452G, 452B are respectively adhered to light incident side surfaces in the polarizing layers 40 of the emitting side polarizing plates 444R, 444G, 444B. The opposite side light-transmissive members 480R, 480G, 480B are respectively adhered to light emitting side surfaces in the polarizing layers 40 of the emitting side polarizing plates 444R, 444G, 444B. However, the invention is not limited to this construction, but the following construction can be also adopted.

For example, in the projector 1010 in accordance with exemplary embodiment 5, the light-transmissive substrate made of sapphire is used as the liquid crystal device side light-transmissive members 452R, 452G, 452B adhered to the light incident side surfaces of the polarizing layers 40 of the emitting side polarizing plates 444R, 444G, 444B, but a polarization separating optical element as explained in exemplary embodiment 2 may be also used instead of this light-transmissive substrate.

Further, in the projector 1010 in accordance with exemplary embodiment 5, the light-transmissive substrate made of sapphire is used as the opposite side light-transmissive members 470R, 470G, 470B adhered to the light incident faces of the incident side polarizing plates 424R, 424G, 424B, but a polarization separating optical element as explained in exemplary embodiment 2 may be also used instead of this light-transmissive substrate.

Further, in the projector 1010 in accordance with exemplary embodiment 5, the opposite side light-transmissive members 480R, 480G, 480B adhered to the light emitting faces of the emitting side polarizing plates 444R, 444G, 444B, and the cross dichroic prism 500 are respectively separated and arranged. However, the opposite side light-transmissive members 480R, 480G, 480B may be also respectively adhered to plural light incident end faces of the cross dichroic prism 500.

Further, in the projector 1010 in accordance with exemplary embodiment 5, the opposite side light-transmissive members 470R, 470G, 470B adhered to the light incident and emitting faces of the incident side polarizing plates 424R, 424G, 424B, and the condenser lenses 300R, 300G, 300B are respectively separated and arranged. However, the opposite side light-transmissive members 470R, 470G, 470B may be also respectively adhered to light emitting faces of the condenser lenses 300R, 300G, 300B.

As mentioned above, the projector of the invention has been explained on the basis of each of the above exemplary embodiments. However, the invention is not limited to each of the above exemplary embodiments, but can be executed in various modes in the scope not departing from its features. For example, the following modifications can be performed.

The explanation has been made with respect to the examples in which the optical device of the invention is applied to the projector, but the invention is not limited to these examples. The optical device of the invention can be also applied to another optical device using polarized light.

In the above exemplary embodiments 1 and 2, the projector 1000 has been explained. This projector 1000 has a structure for nipping the emitting side polarizing plates 440R, 440G, 440B between the first light-transmissive members 450R, 450G, 450B and the cross dichroic prism 500. Otherwise, the projector 1000 has a structure for nipping the incident side polarizing plates 420R, 420G, 420B between the second light-transmissive members 430R, 430G, 430B and the condenser lenses 300R, 300G, 300B. However, the invention is not limited to this projector 1000. A projector having a structure for nipping the polarizing plate between the light-transmissive member and another optical device is also included in the scope of the invention.

In the projector 1000 of each of the above exemplary embodiments 1 and 2, sapphire is used as both the materials of the first light-transmissive members 450R, 450G, 450B and the second light-transmissive members 430R, 430G, 430B, but the invention is not limited to sapphire. Crystal, quartz glass, hard glass, crystallized glass or transparent sintered glass of YAG may be also used in addition to sapphire as the materials of the first light-transmissive members 450R, 450G, 450B or the second light-transmissive members 430R, 430G, 430B. When crystal is used as the material of the first light-transmissive member or the second light-transmissive member, effects similar to those of the case of sapphire can be obtained. Further, when quartz glass, hard glass, crystallized glass or transparent sintered glass of YAG is used as the material of the first light-transmissive member or the second light-transmissive member, these materials are small in birefringence. Therefore, it is possible to restrain a reduction in quality of a light beam passing through the first light-transmissive member or the second light-transmissive member. Further, these materials are comparatively small in coefficient of thermal expansion. Therefore, deformation of the polarizing plate itself can be restrained by adhering the polarizing plate having a property large in extension and deformation due to heat to the first light-transmissive member or the second light-transmissive member made of such a material small in coefficient of thermal expansion. Further, another transparent glass (e.g., white plate glass, Pyrex™, etc.), YAG polycrystal, oxynitriding aluminum, etc. can be also suitably used as the materials of the first light-transmissive member and the second light-transmissive member, Namely, it is sufficient to construct the first light-transmissive members 450R, 450G, 450B and the second light-transmissive members 430R, 430G, 430B by inorganic materials.

In the above description, a suitable selection can be similarly made from the above inorganic materials with respect to the liquid crystal device side light-transmissive members 432R, 432G, 432B, 452R, 452G 452B or the opposite side light-transmissive members 470R, 470G, 470B, 480R, 480G, 480B in the projectors 1006 to 1010 in the above exemplary embodiments 3 to 5.

According to the projectors 1008 and 1010 in the above embodiments 4 and 5, the liquid-crystal-device-side transparent members 432R, 432G, and 432B and the opposite-side transparent members 470R, 470G, and 470B are located so that these optical axes are approximately in parallel with or perpendicular to the polarizing axis of the polarizing layer 20. But, the invention is not limited this arrangement. Further, according to the projectors 1008 and 1010 in the above embodiments 4 and 5, the liquid-crystal-device-side transparent members 452R, 452G, and 452B and the opposite-side transparent members 480R, 480G, and 480B are located so that these optical axes are approximately in parallel with or perpendicular to the polarizing axis of the polarizing layer 40. But, the invention is not limited this arrangement. The liquid-crystal-device-side transparent members 432R, 432G and 432B and the opposite-side transparent members 470R, 470G, and 470B may be located so that the optical axes of the liquid-crystal-device-side transparent members 432R, 432G, and 432B may be further in parallel with or perpendicular to the polarizing axis of the polarizing layer 20, comparing with the optical axes of the opposite-side transparent members 470R, 470G and 470B. Further, the liquid-crystal-device-side transparent members 452R, 452G, and 452B and the opposite-side transparent members 480R, 480G ad 480B may be located so that the optical axes of the liquid-crystal-device-side transparent members 452R, 452G, and 452B may be further in parallel with or perpendicular to the polarizing axis of the polarizing layer 40, comparing with the optical axes of the opposite-side transparent members 480R, 480G, and 480B.

The reasons of this arrangement are followings. First, the deviated amount of the optical axis of the liquid-crystal-device-side transparent members 432R, 432G, 432B, 452R, 452G and 452B largely affects the contrast of an image comparing with that of the optical axis of the opposite-side transparent members 470R, 470G, 470B, 480R, 480G, and 480B. Second, the large deviation of the optical axis of the opposite-side transparent members 470R, 470G, 470B, causes the disturbance of the light beam emitted from the polarization converting element. Further; the large deviation of the optical axis of the opposite-side transparent members 480R, 480G, 480B, worsens the transparent efficiency of the integration prism.

In order to avoid the above effects, if the affect to the contrast of a projector is constrained under 10% when a the contrast of a projector is 500:1, for example, an amount of deviation from the optical axis of the liquid-crystal-device-side transparent members 432R, 432G, and 432B to the axis that is in parallel with or perpendicular to the polarizing axis of the polarizing layer 20 may be within 0.5 degrees. Further, the liquid-crystal-device-side transparent members 452R, 452G, and 452B to the axis that is in parallel with or perpendicular to the polarizing axis of the polarizing layer 40 may also be within 0.5 degrees. Further, if the above effect to the light utility efficiency of a projector is constrained under 1 to 2%, for example, an amount of deviation from the optical axis of the opposite-side transparent members 470R, 470G, and 470B to the axis that is in parallel with or perpendicular to the polarizing axis of the polarizing layer 20 may be within 5 degrees. Further, the opposite-side transparent members 480R, 480G and 480B to the axis that is in parallel with or perpendicular to the polarizing axis of the polarizing layer 40 may also be within 5 degrees. Accordingly, an amount of deviation from the optical axes of the liquid-crystal-device-side transparent members 432R, 432G, and 432B to the axis that is in parallel with or perpendicular to the polarizing axis of the polarizing layer 20 may be smaller than an amount of deviation from the optical axes of the opposite-side transparent members 470R, 470G and 470B to the axis that is in parallel with or perpendicular to the polarizing axis of the polarizing layer 20. Similarly, an amount of deviation from the optical axes of the liquid-crystal-device-side transparent members 452R, 452G, and 452B to the axis that is in parallel with or perpendicular to the polarizing axis of the polarizing layer 40 may be smaller than an amount of deviation from the optical axes of the opposite-side transparent members 480R, 480G, and 480B to the axis that is in parallel with or perpendicular to the polarizing axis of the polarizing layer 40.

In the projectors 1008, 1010 of the above exemplary embodiments 4 and 5, the light-transmissive substrate made of sapphire is used as both the liquid crystal device side light-transmissive members 432R, 432G, 432B, 452R, 452G, 452B and the opposite side light-transmissive members 470R, 470G, 470B, 480R, 480G 480B, but the invention is not limited to this light-transmissive substrate. For example, one light-transmissive member among the liquid crystal device side light-transmissive member and the opposite side light-transmissive member may be a light-transmissive substrate made of quartz glass, hard glass, crystallized glass or a sintered body of cubic crystal, and the other light-transmissive member may be a light-transmissive substrate made of sapphire or crystal.

When the temperature of a vicinity of the polarizing plate is higher than a predetermined temperature, the liquid crystal device side light-transmissive members 432R, 432G, 432B, 452R, 452G, 452B are preferably a light-transmissive substrate made of sapphire or crystal from the viewpoint of reducing thermal load of the polarizing plate. The opposite side light-transmissive members 470R, 470G, 470B, 480R, 480G, 480B are preferably a light-transmissive substrate made of quartz glass, hard glass, crystallized glass or a sintered body of cubic crystal from the viewpoint of restraining a reduction in quality of a light beam incident to the polarizing plate, or a light beam emitted from the polarizing plate.

When the temperature of the vicinity of the polarizing plate is lower than the predetermined temperature, the liquid crystal device side light-transmissive members 432R, 432G, 432B, 452R, 452G, 452B are preferably a light-transmissive substrate made of quartz glass, hard glass, crystallized glass or a sintered body of cubic crystal from the viewpoint of restraining the reduction in quality of the light beam incident to the polarizing plate or the light beam emitted from the polarizing plate. The opposite side light-transmissive members 470R, 470G, 470B, 480R, 480G, 480B are preferably a light-transmissive substrate made of sapphire or crystal from the viewpoint of reducing thermal load of the polarizing plate. For example, light-transmissive sintered glass of YAG can be adopted as the sintered body of the cubic crystal.

In the optical device 514 in accordance with the above exemplary embodiment 2, the polarization separating optical elements 460R, 460G, 460B using the XY type polarizing film having polarizing characteristics of the XY type by laminating plural films having the biaxial direction property are illustrated and explained as the polarization separating optical element, but the invention is not limited to these polarization separating optical elements 460R, 460G, 460B. As the polarization separating optical element, for example, it is possible to preferably use a polarization separating optical element constructed by a dielectric multilayer film, a polarization separating optical element of a wire grid type formed by arraying many fine metallic thin films, etc.

In the above exemplary embodiment 1, the optical device 510 having the following structure has been explained. Namely, all of the incident side polarizing plates 420R, 420G, 420B arranged on the light incident sides of the liquid crystal devices 410R, 410G, 410B are respectively nipped between the second light-transmissive members 430R, 430G, 430B and the condenser lenses 300R, 300G, 300B. All of the emitting side polarizing plates 440R, 440G, 440B arranged on the light emitting sides of the liquid crystal devices 410R, 410G, 410B are respectively nipped between the first light-transmissive members 450R, 450G, 450B and the cross dichroic prism 500. However, the invention is not limited to this structure. An optical device having the following structure is also included in the scope of the invention. Namely, at least one incident side polarizing plate among the incident side polarizing plates 420R, 420G, 420B is nipped between the second light-transmissive members 430R, 430G, 430B and the condenser lenses 300R, 300G, 300B. At least one emitting side polarizing plate among the emitting side polarizing plates 440R, 440G, 440B is nipped between the first light-transmissive members 450R, 450G, 450B and the cross dichroic prism 500.

In the above exemplary embodiment 2, the optical device 514 having the structure for respectively nipping all of the emitting side polarizing plates 440R, 440G, 440B arranged on the light emitting sides of the liquid crystal devices 410R, 410G, 410B between the polarization separating optical elements 460R, 460G, 460B and the cross dichroic prism 500 has been explained. However, the invention is not limited to this structure. An optical device having a structure for nipping at least one emitting side polarizing plate among the emitting side polarizing plates 440R, 440G, 440B between the polarization separating optical elements 460R, 460G, 460B and the cross dichroic prism 500 is also included in the scope of the invention.

In the above exemplary embodiment 3, the optical device 518 having the following stricture has been explained. Namely, all of the incident side polarizing plates 420R, 420G, 420B arranged on the light incident sides of the liquid crystal devices 410R, 410G, 410B are adhered to the liquid crystal device side light-transmissive members 432R, 432G; 432B. All of the emitting side polarizing plates 440R, 440G; 440B arranged on the light emitting sides of the liquid crystal devices 410R, 410G, 410B are adhered to the liquid crystal device side light-transmissive members 452R, 452G; 452B. However, the invention is not limited to this structure. An optical device having the following structure is also included in the scope of the invention. Namely, at least one incident side polarizing plate among the incident side polarizing plates 420R, 420G, 420B is adhered to the liquid crystal device side light-transmissive members 432R, 432G, 432B. At least one emitting side polarizing plate among the emitting side polarizing plates 440R, 440G, 440B is adhered to the liquid crystal device side light-transmissive members 452R, 452G, 452B.

In the above exemplary embodiment 4, the optical device 518 having the following structure has been explained. Namely, all of the incident side polarizing plates 420R, 420G, 420B arranged on the light incident sides of the liquid crystal devices 410R, 410G, 410B are respectively nipped between the liquid crystal device side light-transmissive members 432R, 432G, 432B and the opposite side light-transmissive members 470R, 470G, 470B. All of the emitting side polarizing plates 440R, 440G, 440B arranged on the light emitting sides of the liquid crystal devices 410R, 410G, 410B are respectively nipped between the liquid crystal device side light-transmissive members 452R, 452G, 452B and the opposite side light-transmissive members 480R, 480G, 480B. However, the invention is not limited to this structure. An optical device having the following structure is also included in the scope of the invention. Namely, at least one incident side polarizing plate among the incident side polarizing plates 420R, 420G, 420B is nipped between the liquid crystal device side light-transmissive members 432R, 432G, 432B and the opposite side light-transmissive members 470R, 470G, 470B. At least one emitting side polarizing plate among the emitting side polarizing plates 440R, 440G, 440B is nipped between the liquid crystal device side light-transmissive members 452R, 452G, 452B and the opposite side light-transmissive members 480R, 480G, 480B.

in the above exemplary embodiment 5, the optical device 520 having the following structure has been explained. Namely, all of the incident side polarizing plates 424R, 424G, 424B arranged on the light incident sides of the liquid crystal devices 410R, 410G, 410B are respectively nipped between the liquid crystal device side light-transmissive members 432R, 432G, 432B and the opposite side light-transmissive members 470R, 470G, 470B. All of the emitting side polarizing plates 444R, 444G, 444B arranged on the light emitting sides of the liquid crystal devices 410R, 410G, 410B are respectively nipped between the liquid crystal device side light-transmissive members 452R, 452G 452B and the opposite side light-transmissive members 480R, 480G, 480B. However, the invention is not limited to this structure. An optical device having the following structure is also included in the scope of the invention. Namely, at least one incident side polarizing plate among the incident side polarizing plates 424R, 424G, 424B is nipped between the liquid crystal device side light-transmissive members 432R, 432G, 432B and the opposite side light-transmissive members 470R, 470G, 470B. At least one emitting side polarizing plate among the emitting side polarizing plates 444R, 444G, 444B is nipped between the liquid crystal device side light-transmissive members 452R, 452G, 452B and the opposite side light-transmissive members 480R, 480G, 480B.

In a modified example of the above exemplary embodiment 1, when the polarizing plate (polarizing layer 20) having a structure for also omitting the support layer of the light emitting side as well as the support layer of the light incident side is adhered to the first light-transmissive member and the cross dichroic prism, it is preferable that the polarizing layer 20 is first adhered to one of the first light-transmissive member and the cross dichroic prism through an adhesive, and heat treatment is then taken and the polarizing layer 20 is then adhered to the other. Further, when the polarizing layer 20 is adhered to the second light-transmissive member and the condenser lens, it is preferable that the polarizing layer is first adhered to one of the second light-transmissive member and the condenser lens through an adhesive, and heat treatment is then taken and the polarizing layer is then adhered to the other. In this case, in the heat treatment, a leaving operation is performed for 0.5 to 10 hours in an environment of 80 degrees to 110 degrees centigrade. Thus, since initial contraction due to heat of polarizing layer 20 is performed, damage of the polarizing layer 20 due to thermal stress can be prevented even when the polarizing layer 20 is assembled into the projector 1000 and light is irradiated and heat is applied.

In the above exemplary embodiment 5, when the polarizing layer 20 having no support layer is adhered to the liquid crystal device side light-transmissive member and the opposite side light-transmissive member; it is preferable that the polarizing layer 20 is first adhered to one of the liquid crystal device side light-transmissive member and the opposite side light-transmissive member through an adhesive and heat treatment is then taken and the polarizing layer 20 is then adhered to the other. In this case, in the heat treatment, a leaving operation is performed for 0.5 to 10 hours in an environment of 80 degrees to 110 degrees centigrade. Thus, since initial contraction due to heat of polarizing layer 20 is performed, damage of the polarizing layer 20 due to thermal stress can be prevented even when the polarizing layer 20 is assembled into the projector 1010 and light is irradiated and heat is applied.

In the projector 1000 of the above exemplary embodiment 1, the light source device 110 having the elliptical face reflector 114, the light emitting tube 112 having a light emitting center near a first focal point of the elliptical face reflector 114, and the concave lens 118 is used as a light source device. However, the invention is not limited to this light source device, but it is possible to preferably use a light source device having a parabolic reflector and a light emitting tube having a light emitting center near a focal point of the parabolic reflector.

In the projector 1000 of the above exemplary embodiment 1, the case for arranging the auxiliary mirror 116 as a reflecting means in the light emitting tube 112 has been illustrated and explained. However, the invention is not limited to this case, but can be also applied to a structure in which no auxiliary mirror is arranged in the light emitting tube.

In the projector 1000 of the above exemplary embodiment 1, the lens integrator optical system constructed by the lens array is used as a light uniforming optical system. However, the invention is not limited to this optical system, but a rod integrator optical system constructed by a rod member can be also preferably used.

In each of the above exemplary embodiments, the projector using the three liquid crystal devices 410R, 410G, 410B has been illustrated and explained. However, the invention is not limited to this projector, but can be also applied to a projector using one, two, or four or more liquid crystal devices.

The invention can be also used in a case applied to a front projecting type projector for projecting a projecting image from its observing side, and a case applied to a rear projecting type projector for projecting the projecting image from the side opposed to the observing side.

The priority applications Numbers JP2005-193440, JP2006-047871, JP2006-047872, JP2006-047873, JP2006-121650, JP2006-121651, JP20066-121652, 2006-172244, JP2006-172245 and JP2006-172246 upon which this patent application is based is hereby incorporated by reference.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

What is claimed is:

1. A projector comprising;
an illuminating device that emits an illumination light beam;
a liquid crystal device that modulates the illumination light beam emitted from the illuminating device in accordance with image information;
a projection optical system that projects the light beam modulated by the liquid crystal device; and
a polarizing plate arranged on at least one of an incident side and an emission side of the liquid crystal device and having a polarizing layer and a supporting layer that supports the polarizing layer,
the supporting layer being arranged on only a side opposite to the liquid crystal device side in the polarizing layer.

2. The projector according to claim 1, further comprising;
a liquid-crystal-device-side light-transmissive member bonded to a surface of the liquid crystal device side in the polarizing plate.

3. The projector according to claim 2,
the liquid-crystal-device-side light-transmissive member being a light-transmissive substrate made of sapphire or quartz.

4. The projector according to claim 3,
the light-transmissive substrate made of sapphire or quartz being arranged on the polarizing plate such that an optic axis of the light-transmissive substrate made of sapphire or quartz is substantially parallel to or orthogonal to a polarizing axis of the polarizing layer.

5. The projector according to claim 2,
the liquid-crystal-device-side light-transmissive member being the light-transmissive substrate made of quartz glass, hard glass, crystallized glass, or sintered body of cubic crystal.

6. The projector according to claim 2,
when the polarizing plate is arranged on the emission side of the liquid crystal device, the liquid-crystal-device-side light-transmissive member is a polarization splitting optical element that transmits linearly polarized light components having a predetermined axis among incident light components and reflects the other light components.

7. The projector according to claim 1, further comprising:
an opposite-side light-transmissive member bonded to a surface of a side opposite to the liquid crystal device side in the polarizing plate.

8. The projector according to claim 7,
the opposite-side light-transmissive member being the light-transmissive substrate made of sapphire or quartz.

9. The projector according to claim 8,
the light-transmissive substrate made of sapphire or quartz being arranged on the polarizing plate such that an optic axis of the light-transmissive substrate made of sapphire or quartz is substantially parallel to or orthogonal to a polarizing axis of the polarizing layer.

10. The projector according to claim 7,
the opposite-side light-transmissive member being the light-transmissive substrate made of quartz glass, hard glass, crystallized glass, or sintered body of cubic crystal.

11. The projector according to claim 7,
when the polarizing plate is arranged on the incident sides of the liquid crystal devices, the opposite-side light-transmissive member is a polarization splitting optical element that transmits linearly polarized light components having a predetermined axis among incident light components and reflects the other light components.

12. The projector according to claim 7, further comprising:
a condensing lens arranged on the incident side of the liquid crystal device,
the opposite-side light-transmissive member bonded to the polarizing plate arranged on the incident side of the liquid crystal device being bonded to an emission surface of the condensing lens.

13. The projector according to claim 7, further comprising:
a color separating light guide optical system that separates a light beam emitted from the illuminating device into a plurality of color light beams and guides the separated color light beams to illuminated regions;
plural liquid crystal devices that modulates each of the plural color lights separated by the color separating light guide optical system in accordance with the image information as the liquid crystal device; and
a cross dichroic prism that has a plurality of incident surfaces on which the color light beams modulated by the liquid crystal devices are incident and an emission surface from which a combined color light beam is emitted,
the polarizing plate having the liquid-crystal-device-side light-transmissive member and the opposite-side light-transmissive member boned to both surfaces thereof being arranged on the emission side of at least one of the liquid crystal devices, and
the opposite-side light-transmissive member being bonded to the incident surface of the cross dichroic prism.

14. The projector according to claim 1, further comprising:
a liquid-crystal-device-side light-transmissive member bonded to a surface of the liquid crystal device side in the polarizing plate; and
an opposite-side light-transmissive member bonded to a surface of the side opposed to the surface of the liquid crystal device side in the polarizing plate,
the liquid-crystal-device-side light-transmissive member and the opposite-side light-transmissive member being a light-transmissive substrates made of sapphire or quartz,
an amount of deviation from the optic axis of the liquid-crystal-device-side light-transmissive member to the axis that is in parallel with or perpendicular to the polarizing axis of the polarizing layer being smaller than an amount of deviation from the optic axis of the opposite-side light-transmissive member to the axis that is in parallel with or perpendicular to the polarizing axis of the polarizing layer.

15. The projector according to claim 14, further comprising:
a condensing lens arranged on the incident side of the liquid crystal device,
the opposite-side light-transmissive member bonded to the polarizing plate arranged on the incident side of the liquid crystal device being bonded to an emission surface of the condensing lens.

16. The projector according to claim 14, further comprising:
a color separating light guide optical system that separates a light beam emitted from the illuminating device into a plurality of color light beams and guides the separated color light beams to illuminated regions;
plural liquid crystal devices that modulates each of the plural color lights separated by the color separating light guide optical system in accordance with the image information as the liquid crystal device; and
a cross dichroic prism that has a plurality of incident surfaces on which the color light beams modulated by the liquid crystal devices are incident and an emission surface from which a combined color light beam is emitted,
the polarizing plate having the liquid-crystal-device-side light-transmissive member and the opposite-side light-transmissive member boned to both surfaces thereof being arranged on the emission side of at least one of the liquid crystal devices, and
the opposite-side light-transmissive member being bonded to the incident surface of the cross dichroic prism.
